(19) United States
(12) Patent Application Publication
(10) Pub. No.: US 2026/0025474 A1
(43) Pub. Date: Jan. 22, 2026

(54) INFRARED CORRECTION FOR VISIBLE AND INFRARED LIGHT SENSOR DATA IN OCCUPANT AND DRIVER MONITORING SYSTEMS

(71) Applicant: NVIDIA Corporation, Santa Clara, CA (US)

(72) Inventors: Gopal Triplicane VENKATESAN, Sunnyvale, CA (US); Animesh KHEMKA, Fremont, CA (US)

(21) Appl. No.: 18/774,612

(22) Filed: Jul. 16, 2024

(51) Int. Cl. H04N 1/60; G06T 5/20; G06T 7/90; G06V 10/56

(52) U.S. Cl. CPC H04N 1/60; G06T 5/20; G06T 7/90; G06V 10/56; G06T 2207/10024; G06T 2207/10048

(57) ABSTRACT

In various examples, infrared correction for visible wavelength color data channel processing systems and applications are provided. An ISP pipeline may define a local support region for a pixel that is being processed for IR correction. A locally adaptive IR correction function computes color channel and IR channel value estimates for a target pixel based on spatial filtering of pixels in the local support region. Localized corrections may be applied based on local color channel metrics derived from the local support region. The IR correction function may apply a first scaling factor to the IR value estimate prior to subtraction from the initial color value estimates for the RGB color channels to retain residual color information that otherwise might be lost. Other scaling factors may be applied to restore a saturated RGB color channel to a saturated value due to high RGB color levels.

### BACKGROUND

Advanced Driver Assistance Systems (ADASs) represent an evolving technology in the automotive industry to provide features such as occupant monitoring systems (OMSs) and driver monitoring systems (DMSs). OMSs and DMSs perform real-time assessments of driver and occupant presence, gaze, alertness, or other conditions for reliable detection and recognition of safety-critical information. Increasingly, the optical image sensors used to capture image data for these OMS assessments are devices that capture image frames that simultaneously include visual spectrum color data (e.g., red, green and/or blue (RGB) color data) as well as non-visible infrared (IR) data. As used herein, IR data refers to data representing non-visible infrared wavelengths of electromagnetic radiation (IR light) in captured image data, and may include, for example, wavelengths categorized as near-infrared, infrared, and/or far-infrared. For example, an OMS optical image sensor may comprise a monocular optical image sensor, such as a camera, that captures both color and IR image streams (RGB-IR) as image frames of a vehicle interior.

### SUMMARY

Embodiments of the present disclosure relate to infrared correction for visible wavelength color data channel processing systems and applications. Systems and methods are disclosed that provide an image signal processor (ISP) pipeline that addresses the issues of processing image data that includes a substantial IR component by implementing an ISP pipeline that includes a locally adaptive IR correction function that adjusts the amount of IR value that is subtracted from each color pixel for IR correction purposes, based on tonal and IR-to-color ratio metrics measured in the vicinity of the pixel.

In contrast to conventional systems, on a pixel-by-pixel basis, a local support region may be defined for (e.g., centered on) a pixel that is being processed by the ISP pipeline for IR correction. In some embodiments, to implement the locally adaptive IR correction function, an ISP pipeline may receive an input comprising the pixel value data (e.g., R, G, B, and IR channel data) for a target image pixel captured by an optical sensor (e.g., the pixel to which IR correction is being applied) and additionally the pixel value for the other image pixels that define the local support region around the target image pixel.

Based on the pixels of the local support region, the locally adaptive IR correction function computes RGB color value estimates for the RGB color channels of the target image pixel. In some embodiments, the locally adaptive IR correction function of the ISP computes an initial (e.g., uncorrected) color channel value estimate for the target image pixel based on spatial filtering of the immediate pixel neighborhood (the local support region). In a similar way, for a given target image pixel, the locally adaptive IR correction function computes an IR value estimate based on spatial filtering of not only the IR channel within the local support region but also other color channels as well. Localized corrections are applied based, for example, on a combination of IR-over-color-ratio for pixels and tonal level metrics in a pixel's neighborhood. For example the ISP pipeline may apply a locally adaptive IR correction function that applies a first scaling factor to the IR value estimate prior to subtraction from the initial color value estimates for the RGB color channels to retain residual color information that otherwise might be lost. Other scaling factors may be applied to restore a saturated RGB color channel to a saturated value to account for when an RGB color channel would still be saturated due to high RGB color levels even after the channel was corrected to remove IR data. The first and second scaling factors may be computed in a manner such that they vary smoothly across regions and boundaries of the image to prevent image artifacts.

### BRIEF DESCRIPTION OF THE DRAWINGS

The present systems and methods for infrared correction for visible wavelength color data channel processing systems and applications are described in detail below with reference to the attached drawing figures, wherein:

FIG. 1 is a data flow diagram for a process for an example adaptive IR correction-based ISP system, in accordance with some embodiments of the present disclosure;

FIG. 2 is a data flow diagram for an example locally adaptive IR correction function, in accordance with some embodiments of the present disclosure;

FIG. 3A is a diagram illustrating an example local support region for locally adaptive IR correction, in accordance with some embodiments of the present disclosure;

FIGS. 3B and 3C are diagrams illustrating example color filter array patterns, in accordance with some embodiments of the present disclosure;

FIG. 4 is a diagram illustrating example curves for computing scale factors, in accordance with some embodiments of the present disclosure;

FIG. 5 is flow chart illustrating an example method for adaptive IR correction, in accordance with some embodiments of the present disclosure;

FIG. 6A is an illustration of an example autonomous vehicle, in accordance with some embodiments of the present disclosure;

FIG. 6B is an example of camera locations and fields of view for the example autonomous vehicle of FIG. 6A, in accordance with some embodiments of the present disclosure;

FIG. 6C is a block diagram of an example system architecture for the example autonomous vehicle of FIG. 6A, in accordance with some embodiments of the present disclosure;

FIG. 6D is a system diagram for communication between cloud-based server(s) and the example autonomous vehicle of FIG. 6A, in accordance with some embodiments of the present disclosure;

FIG. 7 is a block diagram of an example computing device suitable for use in implementing some embodiments of the present disclosure; and

FIG. 8 is a block diagram of an example data center suitable for use in implementing some embodiments of the present disclosure.

### DETAILED DESCRIPTION

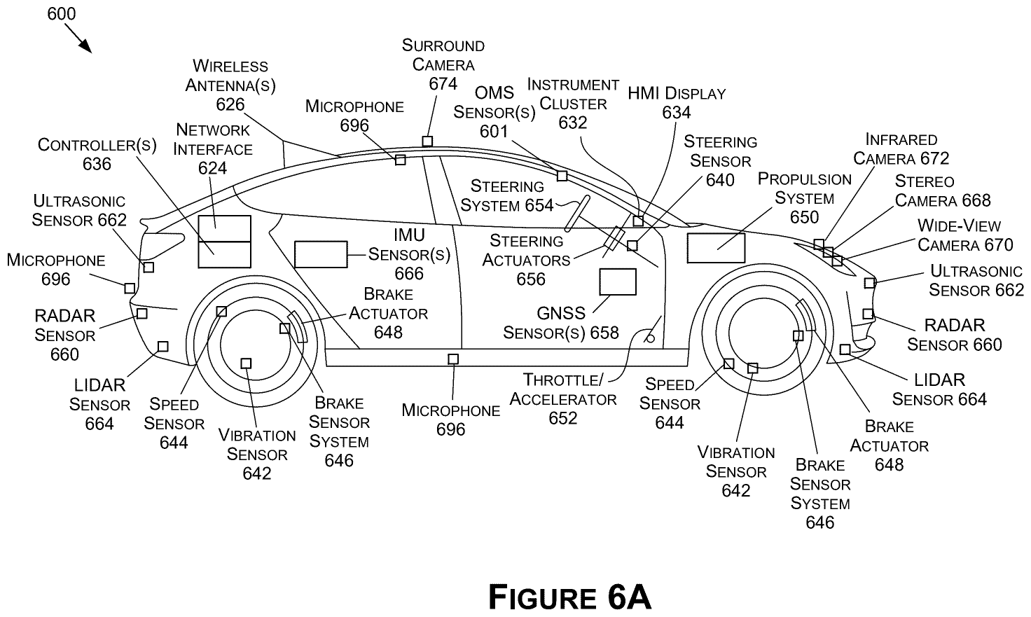

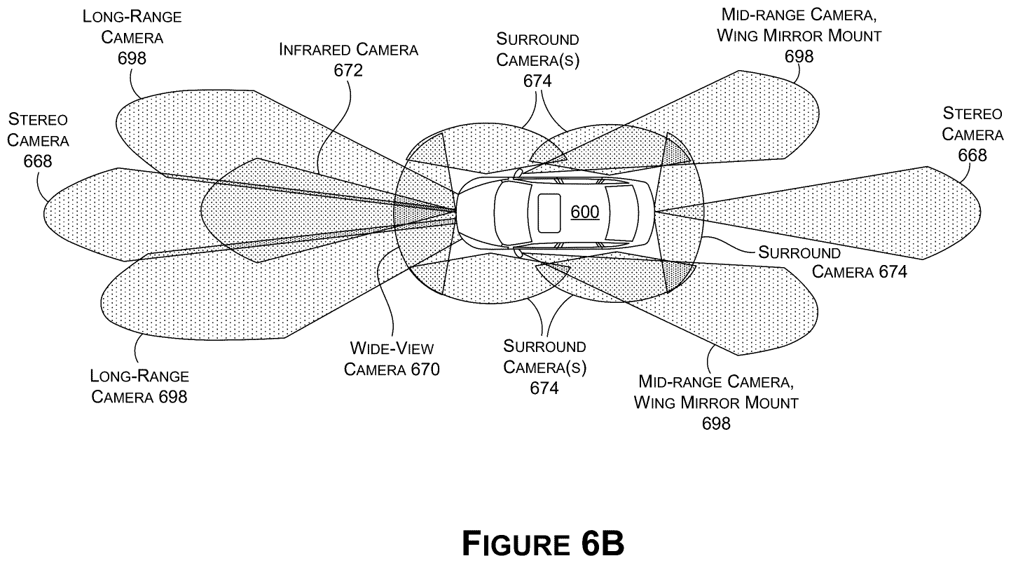

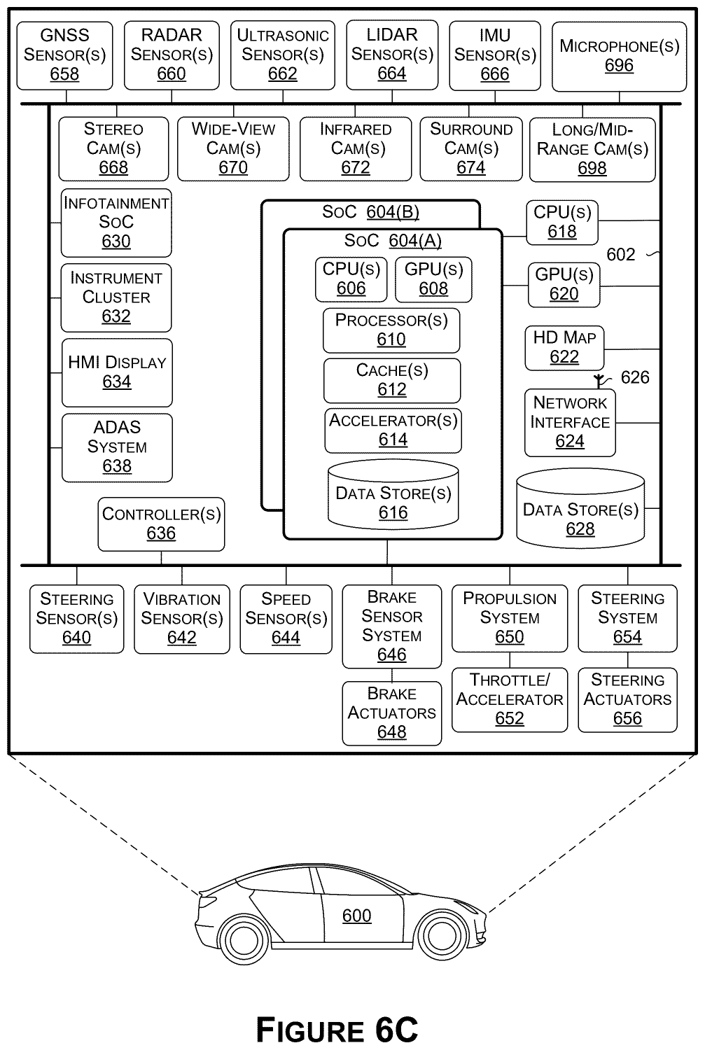

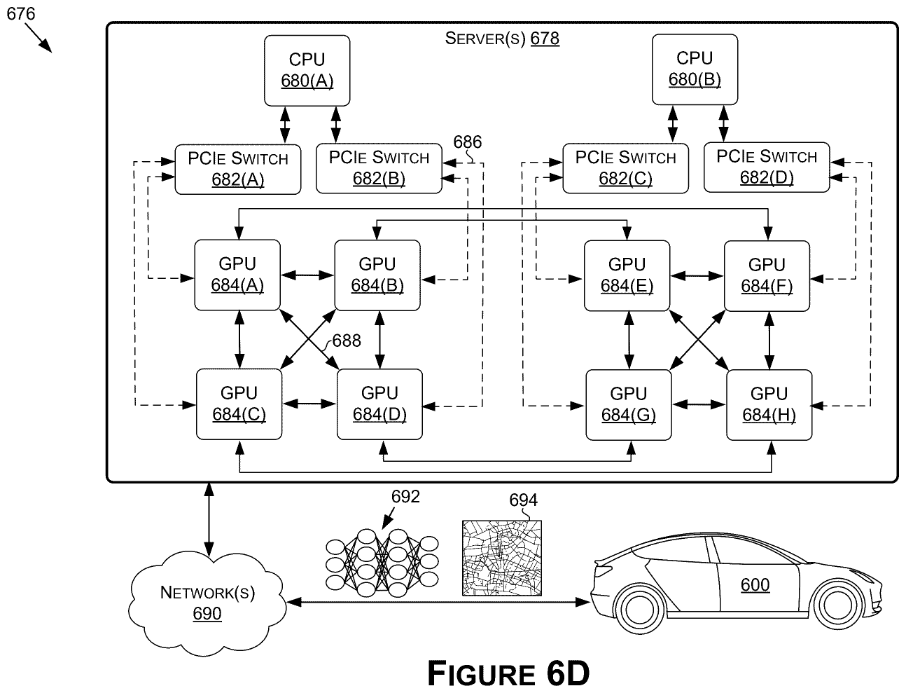

Systems and methods are disclosed related to infrared correction for visible wavelength color data channel processing systems and applications. Although the present disclosure may be described with respect to an example autonomous or semi-autonomous vehicle or machine 600 (alternatively referred to herein as “vehicle 600” or “ego machine 600,” an example of which is described with respect to FIGS. 6A-6D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to image signal processing for automotive applications, this is not intended to be limiting, and the systems and methods described herein may be used in augmented reality, virtual reality, mixed reality, robotics, security and surveillance, autonomous or semi-autonomous machine applications, and/or any other technology spaces where infrared correction for visible wavelength color channels may be used.

The optical image sensors used to capture image data for occupant monitoring systems (OMSs) and Driver Monitoring Systems (DMSs) are primarily devices that capture image frames that include visual spectrum color data (e.g., RGB data) as well as non-visible infrared (IR) data. Because image sensors (such as complementary metal-oxide-semiconductor (CMOS) sensors) have a strong response to IR and near-IR wavelength light, many RGB and monochrome cameras include an IR cut filter (e.g., a coating or element in the camera lens stack), to at least partially remove IR wavelength light from RGB color channels. However, for image sensors that are intended to provide RGB-IR image streams, an IR cut filter is less advantageous as it attenuates the sensor's ability to obtain an accurate measurement of IR wavelength light. As such, for RGB-IR sensors, a substantial amount of IR wavelength light can still reach and affect the values of the RGB color data channels. Although IR light does accurately convey details about structures, objects, and/or backgrounds of a scene, it does so based on a spectrum of light not visible to human beings. Computer-generated graphical renderings of a scene based on IR light therefore may not visually appear the same as the scene would appear to a human being with the naked eye. As such, with respect to color image processing of RGB color data, the presence of IR data in the color channels has been considered a source of contamination and noise.

Currently, image signal processors (ISPs) that process image sensor RGB-IR image data may separate out color information by subtracting an estimate of IR contribution at each color channel of a pixel early in the pipeline. That is, in some embodiments, an RGB-IR color filter array (CFA) refers to a construct of individual pixels that are each associated with a photo-sensitive sensor element of the image sensor assigned to a color channel. The color channel associated with a pixel of an image sensor is in part a function of the pattern of the CFA filter used with the image sensor, and what color the CFA filter passes to the photo-sensitive sensor element for a pixel. Where the CFA filter passes red light to the photo-sensitive sensor element, then the color channel for the pixel is a red color channel. Where the CFA filter passes green light to the photo-sensitive sensor element, then the color channel for the pixel is a green color channel. Where the CFA filter passes blue light to the photo-sensitive sensor element, then the color channel for the pixel is a blue color channel. Where the CFA filter passes IR light to the photo-sensitive sensor element, then the color channel for the pixel is an IR channel.

RGB color channels for a pixel are generally formed in an ISP by correcting RGB color channel values of the pixel for an IR component (which may be established based on data from an IR channel). When the ISP receives the raw image data from the camera, the R, G, and B color channels associated with the pixels of an image frame are contaminated by an IR signal component. To correct for this at each color pixel location, an IR component estimate is subtracted, and the remaining values in the R, G, and B color channels are used as the R, G, and B color data. In some instances, the local IR estimate could be scaled and clipped based on global frame settings. The resulting R, G, and B color channels are then processed separately by the ISP.

The ISP thus separates the color information from IR information in RGB color channels by subtracting an estimate of the IR intensity to provide color images having acceptable image quality (IQ) consistent with human vision and machine-perception needs. However, this IR channel subtraction operation can result in image artifacts in the RGB color channels if, for example, tonal values are clipped or close to being clipped (e.g., where any of the RGB color and/or IR intensities has experienced a non-linear change in values such as saturation), and/or where an IR-to-color ratio (e.g., IR/R, IR/B, or IR/G) is close to or higher than 1.0. These artifacts can occur in an image due to several reasons including over-exposure, illumination characteristics, and object reflectance. Moreover, a problem with standard IR subtraction techniques for forming corrected RGB pixel values is that the subtraction operation is based on several assumptions that may not hold true globally over an entire image frame. These effects are dictated by various uncontrollable factors that include illumination characteristics (both visible and IR) and reflectance of objects in the scene. For example, the reflectivity for IR wavelength light is high, and in a reflective (or bright daylight) environment the IR channel of a pixel may saturate quickly-resulting in a non-linearity in the values of the IR channel, making it difficult to use the IR channel as the basis to accurately subtract IR effects from RGB color channels. For example, because the IR channel for a pixel has a high sensitivity to IR light, then even just ambient lighting and reflections can sometime result in IR values that are greater than the RGB color value captured at a pixel. In such circumstances, attempting an IR correction by subtracting the IR channel value from the color channel value can produce a zero value in the color channel, essentially destroying the color channel measurement. Moreover, signal-to-noise ratio (SNR) degradation can result in areas of mid and low tones that contain critical features for detection and perception results. That is, the SNR could be degraded in low and mid tone areas that represent details of critical features, if the IR estimate is subtracted. While reducing the amount of IR subtracted from the color estimates on a frame-by-frame basis can alleviate image artifacts and SNR degradation in some situations, frame-by-frame global tuning of IR subtraction cannot consistently improve IQ across a wide variety of scenes.

In contrast to traditional ISP pipelines, embodiments of this disclosure provide an ISP pipeline that addresses the issues of processing image data that includes a substantial IR component by implementing an ISP pipeline that includes a locally adaptive IR correction function that varies the amount of IR value that is subtracted from each color pixel for IR correction purposes, based on tonal and IR-to-color ratio metrics measured in the vicinity of the pixel. Localized corrections are applied based, for example, on a combination of IR-over-color-ratio for pixels and tonal level metrics in a pixel's neighborhood (e.g., a defined proximity around the pixel). In embodiments described herein, the ISP pipeline may estimate a ratio of IR over color, and apply an attenuation to the IR subtraction (e.g., scale the IR subtraction) to retain residual color information that otherwise might be lost. An individual IR value estimate is computed for a pixel based on its pixel neighborhood (e.g., a neighborhood comprising a 5×5 pixel region—or other n×n pixel region—centered on that pixel, or other limited subset/region of pixels that is smaller than the set of pixels that defines an image frame as a whole). This immediate pixel neighborhood may be referred to herein as a pixel's local support region.

On a pixel-by-pixel basis, a local support region may be defined for (e.g., centered on) a pixel that is being processed by the ISP pipeline for IR correction. In some embodiments, to implement the locally adaptive IR correction function, an ISP pipeline may receive an input comprising the pixel value data (e.g., R, G, B, and IR channel data) for a target image pixel captured by an optical sensor (e.g., the pixel to which IR correction is being applied) and the pixel value data (e.g., R, G, and B color data and IR channel data) for each of the other image pixels that define the local support region around the target image pixel. For target image pixels located on the edge and/or corner of an image frame, the local support region may be established based on CFA mirroring and/or quad mirroring, to compute estimated values for the missing pixels in the pixel neighborhood around that pixel. For example, for a Bayer pattern CFA, the Bayer quad pattern may be repeated over the region of the missing pixels, and estimates for the missing pixels may be computed based on the color channel values of pixels in one or more Bayer quads' presence within the image frame.

Based on the pixels of the local support region, the locally adaptive IR correction function computes RGB color value estimates for the RGB color channels of the target image pixel. In some embodiments, the locally adaptive IR correction function of the ISP computes an initial (e.g., uncorrected) color channel value estimate for the target image pixel based on spatial filtering of the immediate pixel neighborhood (the local support region). For example, for a red color channel, an initial color value estimate may be computed based on spatial filtering of the immediate pixel neighborhood that may include not only values of the red channel but also other color channel values as well. Similarly, for respective blue and green color channels of a target image pixel, an initial color value estimate may be computed based on spatial filtering of all the color channels appearing within the respective local support region for the target image pixel. In a similar way, for a given target image pixel, the locally adaptive IR correction function computes an IR value estimate based on spatial filtering of not only the IR channel within the local support region but also other color channels as well. Spatial filtering may include applying one or more of, but not limited to, a smoothing spatial filter, a mean filter, an order statistics filter, a sharpening spatial filter, and/or a derivative filter. In some embodiments, the initial color value estimate for a color channel may be computed based on cross-color channel data, for example where the initial color value estimate is based on a weighted average of color channel data from pixels in the local support region of two or more different colors.

Directly subtracting the IR value estimate for a local support region from the initial RGB color channel value estimates may provide a basic localized IR correction for a target pixel that is acceptable for many circumstances. That said, for certain pixel locations in an image frame, image artifacts can be produced in the RGB color channels, for example in circumstances where tonal values are clipped or close to being clipped, and/or where an IR-to-color ratio (e.g., IR/R, IR/B, or IR/G) is close to or higher than 1.0. As such, in some embodiments, the ISP pipeline applies a locally adaptive IR correction function that applies an attenuation to the IR value estimate prior to subtraction from the initial color value estimates for the RGB color channels to retain residual color information that otherwise might be lost.

The attenuation applied to the IR value estimate may comprise a first scaling factor (e.g., a factor ranging from 0 to 1) that is computed or otherwise determined based on local color channel metrics derived from the local support region. For example, one local metric is a local color tonal-value metric that may represent the degree to which an RGB color channel of the target image pixel is saturated and/or how close the RGB color channel is to saturation. In some embodiments, the locally adaptive IR correction function may compute the local color tonal-value metric for a color channel based on spatial filtering of some or all of the color channels within the local support region (e.g., as a luma calculation) and compare that value with a threshold value used to define saturation. Tonal-based metrics may have an increased significance when the image sensor is operating in a scene that is dark and the brightness of light corresponding to the RGB color channel is low. Under such circumstances, it may be detrimental to subtract IR values from what little genuine color signal may be captured by the image sensor.

Another local metric for computing the first scaling factor may include an IR-to-color ratio metric (e.g., IR/R, IR/B, and/or IR/G) computed based on one or more of the initial RGB color value estimates and the IR value estimate computed from the local support region. For both the local color tonal-value metrics and IR-to-color ratio metrics, relatively higher values indicate that a relatively greater degree of downward scaling should be applied by the first scaling factor to the IR value estimate before subtraction of the IR value estimate from the initial color value estimates of the RGB color channels. For example, where an IR-to-color ratio metric for one or more of the RGB color channels is computed as 1.0, then that indicates that the IR is the predominant signal. For example, the color pixel value for RGB-IR may be determined based on the human-visible color value plus the IR value. Hence an IR-to-color ratio may be determined based on IR value/(IR value+human-visible color value). Quantum Efficiency (QE) curves for IR and RGB pixels may be approximately overlapping in the IR band but have small differences. As such, merely subtracting the IR value estimate from the initial color value estimate would eradicate all color data from that RGB color channel. Instead, if based on the IR-to-color ratio metric (and/or the local color tonal-value metric) a non-zero first scaling factor less than 1.0 is computed and applied to attenuate the IR value estimate, then at least some of the color channel data in that RGB color channel is preserved. In this way, a first scaling factor may be determined for each RGB color pixel location to individually adjust the amount of value subtracted to correct for IR contamination.

In some embodiments, one or more of the local color channel metrics derived from the local support region may also be used to compute a second scaling factor that may be applied to one or more of the RGB color channels of the target image pixel after the subtraction of the scaled IR value estimate from the initial RGB color value estimates. The second scaling factor may be used to restore a saturated RGB color channel to a saturated value to account for when an RGB color channel would still be saturated due to high RGB color levels even after the channel was corrected to remove IR data. For example, one or more of the local color channel metrics may indicate that an RGB color channel (e.g., a red, green, or blue color channel) is saturated (e.g., has a channel value of 1.0). If the scaled IR value estimate applied to that RGB color channel has a value of 0.2, then the IR-corrected value of the RGB channel after subtraction of the IR value estimate would be 0.8. However, the one or more of the local color channel metrics derived from the local support region indicate that this RGB channel is indeed saturated (e.g., due to a high level of light of that color reaching the pixels of the local support region). Accordingly, the second scaling factor may be computed and applied to (e.g., upwardly) adjust or scale the RGB color channel data for that channel back to a level that represents saturation (e.g., 1.0). For this example, the RGB channel after subtraction of the IR value estimate is 0.8, so based on the one or more of the local color channel metrics, a second scaling factor of 1.25 may be computed and applied to restore the color channel value back to saturation.

In some embodiments, the first and second scaling factors are computed in a manner such that they vary smoothly across regions and boundaries of the image to prevent image artifacts. The locally adaptive IR correction function may compute the first scaling function and/or the second scaling function based on applying the local color channel metrics derived from the local support region, for example, to a multi-input lookup table, or a multidimensional smoothing function. The scaling functions may be computed using a piecewise linear (PWL) curve and/or using smooth curves. For example, the inputs to a lookup table may include one or more of the IR-to-color ratio values, and/or one or more of the color tonal-value metrics and a first scaling function and/or second scaling function determined based on referencing those inputs to a location on a multi-dimensional surface. Such a multi-dimensional surface may be based on the quantum efficiency (QE) and/or spectral response curves for the image sensor, corresponding to the red, green, and blue colors as well as the IR channel. In some embodiments, the first scaling factor for a color channel may be determined based on a first three-dimensional (3D) surface graph where two input axes correspond to the color tonal-value metric for that color and the IR-to-color ratio metric for that color, and the corresponding point at the surface of the first 3D surface graph represents the first scaling factor. Similarly, in some embodiments, the second scaling factor for a color channel may be determined based on a second 3D surface graph where two input axes correspond to the color tonal-value metric for that color and the IR-to-color ratio metric for that color, and the corresponding point at the surface of the second 3D surface graph represents the second scaling factor. In some embodiments, the multi-input lookup table, multidimensional smoothing function, piecewise linear curves and/or smooth curves, and/or 3D surface graphs may be empirically determined based on testing and or design parameters of the image sensor.

In some embodiments, one or more functions of the locally adaptive IR correction function described herein may be implemented by an ISP pipeline at least in part using a neural network and/or machine learning model. For example, in some embodiments, initial RGB color value estimates, local color channel metrics, and/or one or both of the first and second scaling factors may be inferred based on an input of the pixel data from the local support region to a neural network and/or machine learning model. In some embodiments, one or both of the attenuated IR channel estimates and/or the (e.g., upwardly) scaled RGB color channel data may be inferred based on an input of the pixel data from the local support region by a neural network and/or machine learning model. Moreover, in some embodiments, a neural network and/or machine learning model may be trained to input the pixel data from the local support region for a target pixel and generate an IR correction to the one or more RGB color channels of the target pixel that incorporates the locally adaptive IR adjustments described herein.

In some embodiments, the locally adaptive IR correction function described herein may be implemented as a function of an ISP pipeline embedded in a chip, which inputs a stream of raw pixel data from an image sensor, processes the raw pixel data to computed IR-corrected color channels, and renders (or otherwise generates) an optical image frame comprising pixels based on the IR-corrected color channels. The rendered optical image frame may be presented on a display device for human viewing, used for rendering elements within a virtual environment, and/or used for machine vision applications, such as training machine learning models and/or as inputs to machine learning models that perform other operations based on making inferences/predictions based on the optical image frame. Because image artifacts in the resulting RGB color channels of the IR-corrected optical image frame caused by IR are substantially reduced, downstream systems and functions that use the optical image frame as input receive a more accurate representation of the environment captured by the image sensor, and therefore may themselves operate with a greater degree of accuracy. For example, perception networks of an OMS using the resulting IR-corrected optical image frame are less likely to be confused with respect to interpreting occupant behaviors and/or detecting and understanding objects present within the cabin of a vehicle. In some embodiments, the ISP pipeline may perform one or more operations to adjust image parameters of the IR-corrected optical image frame such as, but not limited to, white balance correction, tone mapping, demosaicing, color noise reduction, color correction, image sharpening, image scaling, or other image adjustments.

It should be appreciated that the embodiments described herein may be used in the context of occupant monitoring for vehicles such as automobiles, trucks, trains, aircraft, spacecraft, and/or boats, but may be extended to other machinery such as remote operated and/or autonomous devices (e.g., robots and drones), and industrial and/or construction machinery, and/or any other image signal processing application such as security, surveillance, night-vision applications, biometric identification applications, and/or area monitoring, using image sensors that capture visible wavelength color data and non-visible wavelength data, such as IR light.

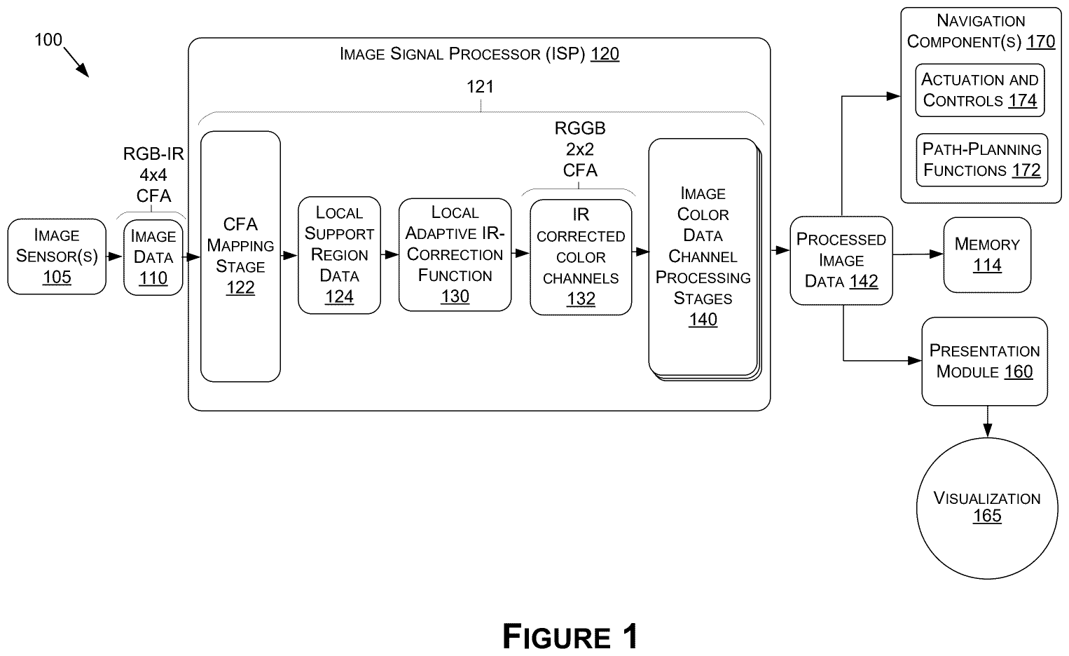

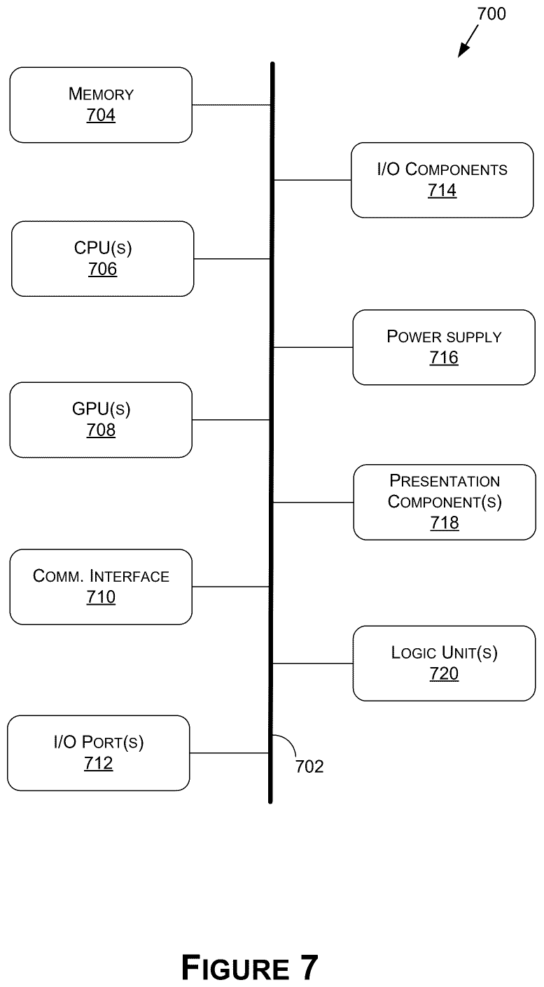

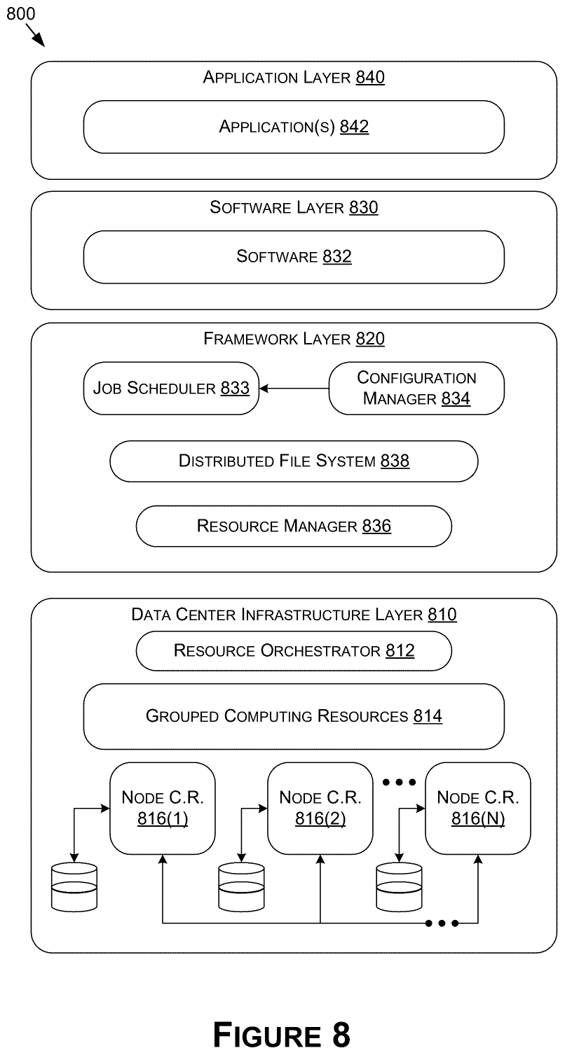

With reference to FIG. 1, FIG. 1 is an example data flow diagram for a process for an adaptive IR correction-based ISP system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 600 of FIGS. 6A-6D, example computing device 700 of FIG. 7, and/or example data center 800 of FIG. 8.

As shown in FIG. 1, an adaptive IR correction-based ISP system 100 may comprise an ISP 120 that includes an ISP pipeline 121 that inputs image data 110 and generates processed image data 142 based on applying one or more image-processing adjustments to the image data 110. In some embodiments, the ISP pipeline 121 may include a color filter array (CFA) mapping stage 122 that receives image data 110 and separates the image data into color channel data and IR channel data. The image data 110 may be produced by one or more image sensors 105 (e.g., a camera) that includes a CFA of small color filters placed over the photo-sensitive sensor element of the image sensor assigned to a color channel of the image sensors 105.

Image sensor(s) 105 may include, for example, RGB cameras, IR cameras, RGB-IR cameras, stereo camera arrays, depth cameras, and/or other cameras, such as cameras described with respect to the vehicle 600 of FIGS. 6A-6D. The image sensor(s) 105 may include one or more cameras of an ego object or ego actor, such as stereo camera(s) 668, wide-view camera(s) 670 (e.g., fisheye cameras), infrared camera(s) 672, surround camera(s) 674 (e.g., 360° cameras), occupant monitoring system (OMS) sensor(s) 601, and/or long-range and/or mid-range camera(s) degree 698 of the autonomous vehicle 600 of FIGS. 6A-6D. The image sensor(s) 105 may be used to generate the image data 110 of the three-dimensional (3D) environment around the ego object or ego actor.

At the pixel level, the CFA filters light so that for each pixel sensor, a designated range of wavelengths-corresponding to a color channel—reaches a given sensor element. A Bayer filter is an example common 2×2 pixel RGB CFA that comprises one blue, one red, and two green filters. In some embodiments, for cameras that capture and generate data for non-visible IR wavelength light, the CFA may further include filter elements that pass the IR wavelength light to pixel sensors. For example, a standard Bayer filter may be adapted for an RGB-IR camera to substitute one of the two green filters with an IR or near-IR wavelength filter. In some embodiments, the image data 110 may have an RGB-IR 4×4 CFA Bayer pattern format. That is, the CFA for an RGB-IR camera may comprise a 4×4 pixel RGB-IR CFA where 2 of 16 pixel filters are red, 2 of 16 pixel filters are blue, 8 of 16 pixel filters are green, and 4 of 16 pixel filters are IR. Although examples of CFA mapping may be described herein with respect to RGB color space, embodiments are not limited to RGB color filter arrays. For example, CFA mapping (e.g., as performed by the CFA mapping stage 122) may, in some embodiments, be performed using other color spaces and color filter arrays such as, but not limited to, RCB (red, clear, blue) and IR, RCG (red, clear, green) and IR, RYCy (red, yellow, cyan) and IR, or other color filter arrays.

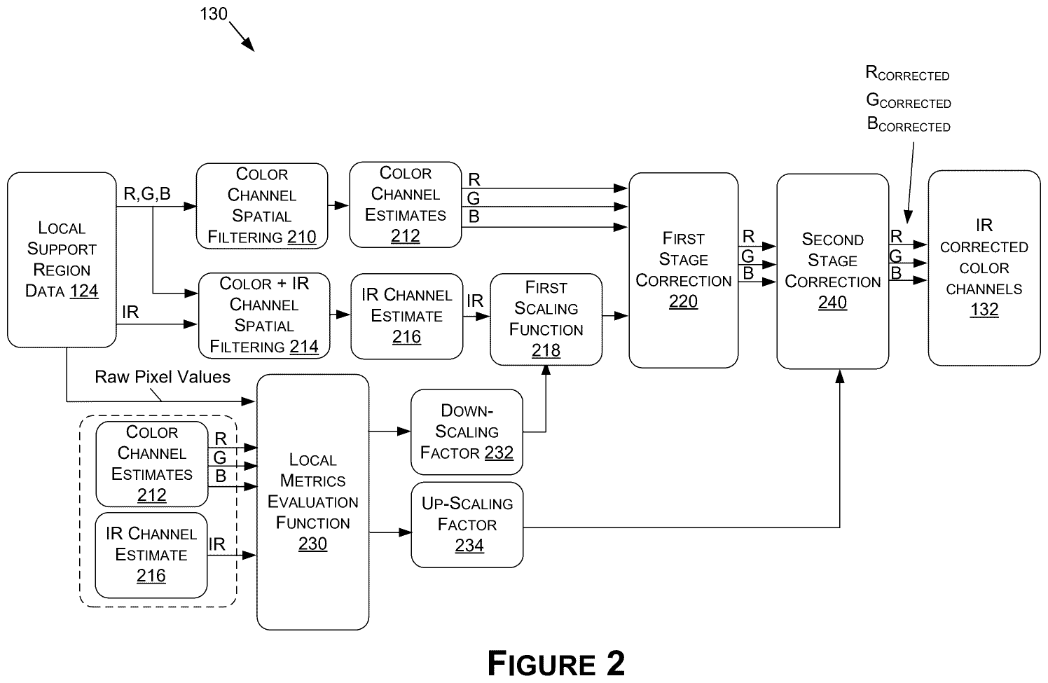

As discussed in greater detail with respect to FIG. 2, in some embodiments, the CFA mapping stage generates an output comprising a set of local support region data 124. For each individual pixel corresponding to the image data, the local support region data 124 includes color channels (e.g., R, G, and B) and an IR channel for the target image pixel (e.g., the pixel to which IR correction is being applied) and the pixel value data (e.g., R, G, and B color data and IR channel data) for each of the other image pixels that define the local support region around the target image pixel.

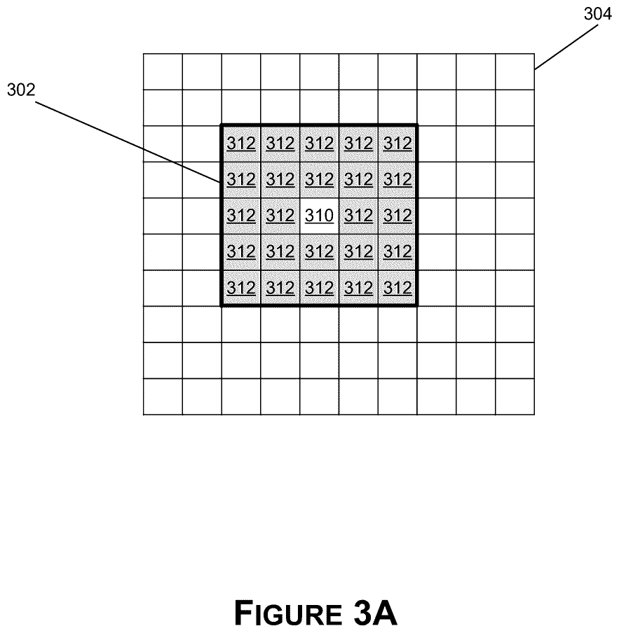

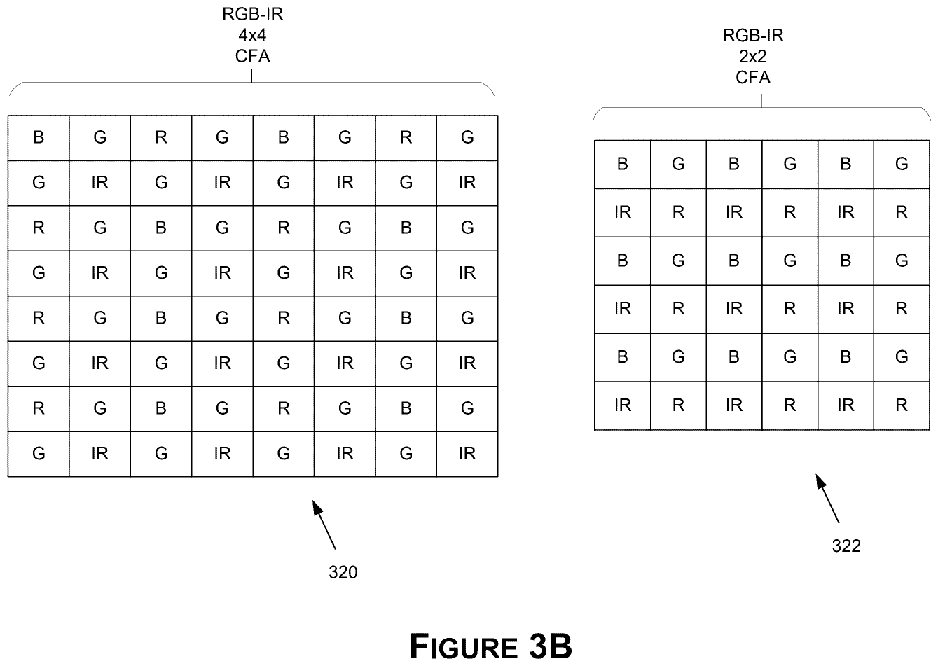

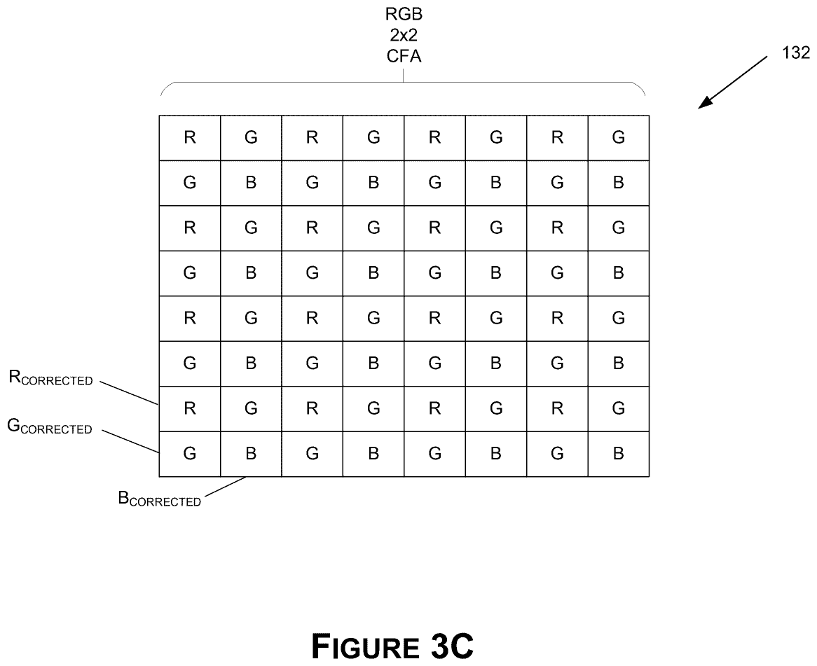

For example, referring to FIG. 3, FIG. 3 illustrates an example local (e.g., support) region 302 (e.g., corresponding to local support region data 124) defined for a target image pixel 310 from an image frame 304 (e.g., corresponding to the image data 110). In this example, the example local support region 302 includes an immediate pixel neighborhood comprising a 5×5 pixel region centered around the target image pixel 310. As discussed herein, to compute an initial (e.g., uncorrected) color channel value (or IR channel value) estimate for target image pixel 310, the locally adaptive IR correction function 130 may compute the estimate using spatial filtering based on the value of the target image pixel 310 and/or the values of neighborhood pixels 312 that define the local support region 302 for the target image pixel 310. Although a 5×5 pixel region is illustrated in FIG. 3A, a local support region 302 may comprise another sized n×n pixel region for a target image pixel that includes a limited subset/region of pixels that is smaller than the set of pixels that defines an image frame 304 as a whole. In some embodiments, the size selected to define the local support region 302 may be based on factors such as the particular CFA pattern associated with the image data 110 (e.g., to ensure a sufficient number of neighborhood pixels 312 are included for each color and/or IR channel to perform an accurate spatial filtering). For purposes of non-limiting illustrative examples, FIG. 3B shows an example of a 4×4 RGB-IR CFA at 320, and an example of a 2×2 RGB-IR CFA at 322.

The local support region data 124 for the target pixel is processed by the locally adaptive IR correction function 130 to generate IR-corrected color channels 132. The locally adaptive IR correction function 130 computes initial (e.g., uncorrected) color channel value estimates for the RGB color channels and an IR channel value estimate for the target image pixel based on spatial filtering. As explained herein and with respect to FIG. 2, the locally adaptive IR correction function 130 further computes and applies one or more scaling factors for adjusting the initial color channel value estimates to generate IR-corrected color channels 132. The IR-corrected color channels 132 may include individually corrected color channels for each color channel of the image data 110. In some embodiments, IR-corrected color channels 132 include RGB color channels that are mapped to a 2×2 RGB CFA, such as but not limited to a red-green-green-blue (RGGB) Bayer quad pattern as shown in FIG. 3C, for example.

In some embodiments, the ISP pipeline 121 may further process the IR-corrected color channels 132 as using a series of image color data channel processing stages 140. Within the plurality of image color data channel processing stages 140, the color data channels are mapped into distinct logical color channels, each having a processing path through the image color data channel processing stages 140. As the color data in the color channels propagates through the image color data channel processing stages 140, each stage applies a filter, transformation, and/or other adjustment to the color channel data, with the processed color channel output of a preceding stage providing the color channel input for the next stage in the sequence of processing stages 140. The particular processes applied to the visible wavelength color data channels by an image color data channel processing stage 140 may include, but are not limited to, demosaicing, white balance correction, tone mapping, color noise reduction, color correction, image sharpening, image scaling, and/or other image adjustments, and so forth as described herein. The results of the processes applied by the image color data channel processing stages 140 may be output from the ISP 120 as processed image data 142. The processed image data 142 resulting output from the ISP pipeline 121 represents the accumulated adjustments to the image data 110 performed by the image color channel processing stages 140 based at least on the IR-corrected color channels 132.

In some embodiments, ISP 120 may receive image data 110 as a (e.g., live or recorded) stream of image data from the image sensor(s) 105. In some embodiments, image data 110 may be previously captured image data provided to the ISP 120 from a memory. The processed image data 142 may be stored to a memory 114 from which it can be read and used as input by one or more other systems or processes such as, but not limited to, further image processing, generating machine language model training data, and/or rendering visualizations.

In some embodiments, a presentation module 160 may cause presentation of a visualization 165 of at least a portion of the processed image data 142 (e.g., on a monitor visible to an occupant or operator of the ego object or ego actor). In some embodiments, the presentation module 160 projects the processed image data 142, or a portion thereof, onto a 3D representation of the 3D environment, renders a view of the processed image data 142 from the perspective of a virtual camera, and/or causes presentation of the rendered view as the visualization 165.

In some embodiments, the processed image data 142 may be used by one or more downstream navigation components 170 of an ego machine, such as the controller(s) 536 discussed below. The downstream navigation components 170, for example, may implement functions such as object avoidance navigation functions and/or a world model manager, a path planner, a control component, a localization component, an obstacle avoidance component, an actuation component, and/or the like, to perform operations for controlling the ego machine through an environment. In some embodiments, downstream navigation components 170 may include one or more deep neural networks (DNNs) that generate one or more predictions and/or inferences about the 3D environment based at least on the processed image data 142.

For some embodiments, the downstream navigation components 170 may include at least one or more path-planning functions 172 (such as path-planning functions for ego machine 600) and/or actuation and controls 174 (such as the steering or break actuators or other controllers discussed herein with respect to ego machine 600). For example, the path-planning functions 172 may include a configuration space manager, a freespace manager, a reachability manager, and a path evaluator. The configuration space manager may manage a pose configuration space, which represents poses comprising positions and orientations of the ego machine in its environment. The freespace manager and the reachability manager may process the pose configuration space to determine one or more paths for maneuvering from a current pose to a target pose in the pose configuration space based at least in part on the processed image data 142. The path evaluator may identify one or more proposed or potential paths for the vehicle based at least on the assessment by the reachability manager.

With reference to FIG. 2, FIG. 2 illustrates an example data flow diagram for an ISP pipeline 121 for an ISP 120, such as is described with respect to the adaptive IR correction-based ISP system 100 of FIG. 1, in accordance with some embodiments of the present disclosure.

As shown in FIG. 2 and discussed with respect to FIG. 1, the image data 110 may be received by a CFA mapping stage 122, and used to assign a local support region data 124 for each pixel represented by the image data 110. Using the individual color channel values represented by the pixels that define the local support region data 124, the locally adaptive IR correction function 130 applies color channel spatial filtering 210 to compute color channel estimates 212. For example, for a set of RGB color channels for a target image pixel, the color channel spatial filtering 210 computes individual R, G, and B color estimates. For example, for a red color channel, color channel spatial filtering 210 computes an initial red color value estimate based on spatial filtering of the local support region data 124 that may include not only values of the red channel but also other color channel values as well. Similarly, for respective blue and green color channels of the target image pixel, the color channel spatial filtering 210 may compute initial blue and green color value estimates based on spatial filtering of all the color channels appearing within the respective local support region for the target image pixel. Similarly, the locally adaptive IR correction function 130 may apply color and IR channel spatial filtering 214 to compute an IR channel estimate 216, based on spatial filtering of not only the IR channel within the local support region, but also other color channels as well. The spatial filtering applied by the locally adaptive IR correction function 130 may include filtering using one or more of, but not limited to, a smoothing spatial filter, a mean filter, an order statistics filter, a sharpening spatial filter, and/or a derivative filter.

As previously mentioned, directly subtracting the IR channel estimate 216 from one or more of the color channel estimates 212 may provide a basic localized IR correction for a target pixel that is acceptable for many circumstances, but can produce undesirable visible artifacts in many circumstances. For example, image artifacts can be produced when direct substitution is used in the RGB color channels, in circumstances where tonal values are clipped or close to being clipped, and/or where an IR-to-color ratio (e.g., IR/R, IR/B, and/or IR/G) is close to or higher than 1.0. As such, in some embodiments the locally adaptive IR correction function 130 applies a first stage correction 220 to the color channel estimates 212 that uses an attenuated (down-scaled) IR channel estimate 216 to perform IR value subtraction from the color channel estimates 212-which serves to retain residual color information that otherwise might be lost.

In some embodiments, the attenuation to the IR channel estimate 216 is applied by a first scaling function 218 based on a first scaling factor 232 (e.g., a down-scaling factor 232 ranging from 0 to 1). The down-scaling factor 232 may be computed by a local color channel metrics evaluation function 230 based on local color channel metrics derived from the value of the target pixel and/or the local support region data 124. That is, in some embodiments the local color channel metrics may be computed using the raw pixel values represented by the local support region data 124. In some embodiments, the local color channel metrics may be computed using the color channel estimates 212 and/or IR channel estimate 216 computed from the local support region data 124.

The down-scaling factor 232 may be computed based on various local color channel metrics. For example, one local metric computed by the local color channel metrics evaluation function 230 may include a local color tonal-value metric that represents the degree to which a color channel is saturated and/or how close the color channel is to saturation. In some embodiments, the locally adaptive IR correction function may compute the local color tonal-value metric for a color channel based on spatial filtering of some or all of the color channels within the local support region data 124 (e.g., as a luma calculation) and compare that value with a threshold value used to define saturation for that color channel. In some embodiments, different thresholds may be defined for different color channels. The local color tonal-value metric may have an increased significance when an image sensor 105 producing the image data 110 is operating in a scene that is dark and the brightness of light corresponding to one or more of the color channels is low. Under such circumstances, it may be detrimental to subtract the value of the IR channel estimate 216 from what little genuine color signal may be represented by the color channel estimates 212. In such cases, the local color channel metrics evaluation function 230 may compute a down-scaling factor 232 that substantially attenuates the IR channel estimate 216 prior to applying the first stage correction 220.

Another local metric that may be computed by the local color channel metrics evaluation function 230 for computing the down-scaling factor 232 may include an IR-to-color ratio metric (e.g., IR/R, IR/B, or IR/G) computed based on one or more of the color channel estimates 212 and IR channel estimate 216. A color pixel value for RGB-IR may be determined based on the human-visible color value plus the IR value. Hence an IR-to-color ratio for a particular R, G, or B color channel may be determined based on

$$\frac{IR Channel Estimate}{IR Channel estimate + Color Channel Estimate} .$$

QE curves for IR and RGB pixels may be approximately overlapping in the IR band but have small differences. For example, if an IR-to-color ratio metric for one of the RGB color channel estimates 212 is computed as 1.0, then that indicates that the IR is the predominant signal in that color channel. As such, merely subtracting the IR value estimate from the initial color value estimate could eradicate all color data from that RGB color channel.

For both the local color tonal-value metrics and IR-to-color ratio metrics, relatively higher values indicate that a relatively greater degree of downward scaling should be applied by the down-scaling factor 232 to the IR channel estimate 212 before the first stage correction 220 subtracts the IR channel estimate 212 from the R, G, and B channels of the color channel estimates 212. If a non-zero down-scaling factor 232 less than 1.0 is computed (e.g., based on the IR-to-color ratio metric and/or the local color tonal-value metric) and applied to attenuate the IR channel estimate 212, then at least some of the color channel data in the color channel estimates 212 is preserved. A down-scaling factor 232 may be determined for a target image pixel for each RGB color pixel location of the image data 110 to individually adjust the amount of value subtracted to correct for IR contamination.

As illustrated in FIG. 2, local color channel metrics evaluation function 230 may also use the local support region data 124 to compute an up-scaling factor 234 that is applied as a second stage correction 240 following the first stage correction 220. The second stage correction 240 using the up-scaling factor 234 may be used to restore the value in the color channel estimates 212 for a color channel that was initially saturated (e.g., to account for instances where an R, G, or B color channel would still be saturated even when value corresponding to IR pollution was removed. For example, one or more of the local color channel metrics may indicate that an RGB color channel (e.g., a red, green, or blue color channel) may be saturated (e.g., has a channel value of 1.0). If the IR channel estimate 216 is scaled (by the down-scaling factor 232) to a value of 0.2, then when the first stage correction 220 subtracts the attenuated IR channel estimate 216 from the color channel estimates 212, the resulting color channel output from the first stage correction 220 would be 0.8. However, this value would not accurately represent a saturated color channel. As such, the one or more of the local color channel metrics derived by the local color channel metrics evaluation function 230 using the local support region data 124 (e.g., using color channel estimates 212 and/or IR channel estimate 216) may be used to detect when one or more of the color channels are indeed saturated (e.g., due to a high level of light of that color reaching the photo-sensitive sensor element). Accordingly, the up-scaling factor 234 may define a second scaling factor that is used by the second stage correction 240 to upwardly scale the color channel data output from the first stage correction 220 for that color channel back to a level that represents saturation (e.g., 1.0). For this example, the RGB color channel after subtraction of the attenuated IR channel estimate 216 is 0.8. The local color channel metrics evaluation function 230 may, on the one or more of the local color channel metrics, determine that one or more of the color channel estimates 212 is saturated, and compute for those color channels an up-scaling factor 234 that reverses the effect of the down-scaling factor 232 to restore those one or more color channels to a saturated value (e.g., 1.0). For example, if saturation is detected based on the local color channel metrics, then the up-scaling factor 234 may be computed as a function of the down-scaling factor 232, such as

$$Up\_Scaling \_Factor = \frac{Saturated Channl Value}{Saturated Channel Value \times Down\_Scaling \_Factor} .$$

For this example, up-scaling factor 234 would be computed as

$$\frac{1}{1 \times 0.8} = 1.25 .$$

By applying the up-scaling factor 234 of 1.25 to the 0.8 color channel value, the second stage correction 240 following the first stage correction 220 restores that channel to the saturation value. First stage correction 220 and second stage correction 240 may thus be performed on the color channel estimates 212 to produce IR-corrected color channels 132 (e.g., comprising an R_{corrected} color channel, a G_{corrected} color channel, and a B_{corrected} color channel). In some embodiments, the local color channel metrics evaluation function 230 may determine that a color channel is not saturated. In that case, the up-scaling factor 234 for that channel may have a value of 1 so that the corrected color channel value as represented in the IR-corrected color channels 132 for that channel would be the value computed by the first stage correction 220. In some embodiments (e.g., for applications, such as low-light conditions, where color channel saturation is not a likely occurrence) the second stage correction 240 may be omitted and the IR-corrected color channels 132 based on the output of the first stage corrections 220.

In some embodiments, the down-scaling factor 232 and the up-scaling factor 234 may be computed in a manner such that the values of the scaling factors vary smoothly across regions and boundaries of the image frame represented by the image data 110 to prevent image artifacts from appearing in an image frame produced from the IR-corrected color channels 132. As an example, the local color channel metrics evaluation function 230 may compute the down-scaling factor 232 based on applying the results of the one or more local color channel metrics derived from the local support region (e.g., the local color tonal-value metric(s) and/or the IR-to-color ratio metric) to a multi-input lookup table, or a multidimensional smoothing function. The down-scaling factor 232 may be computed using a piecewise linear (PWL) curve and/or smooth curves. The up-scaling factor 234 may, in some embodiments, then be computed as a function of the down-scaling factor 232, as described herein.

For example, the inputs to a lookup table used to determine the down-scaling factor 232 and/or up-scaling factor 234 may include one or more of the local color tonal-value metrics and IR-to-color ratio metrics for one or more of the color channels. The down-scaling factor 232 and/or up-scaling factor 234 may be determined based on referencing those inputs to a location on a multidimensional surface. For example, such a multidimensional surface may be based on the quantum efficiency (QE) and/or spectral response curves for the image sensor, corresponding to the red, green and blue colors as well as the IR channel. In some embodiments, the down-scaling factor 232 for a color channel may be determined based on a first 3D surface graph where two input axes correspond to the local color tonal-value metric and the IR-to-color ratio metric for that color, and the corresponding point at the surface of the first 3D surface graph represents the down-scaling factor 232. In some embodiments, the up-scaling factor 234 for a color channel may be determined based on a second 3D surface graph where two input axes correspond to the local color tonal-value metric and the IR-to-color ratio metric for that color, and the corresponding point at the surface of the second 3D surface graph represents the up-scaling factor 234. In some embodiments, the multi-input lookup table, multi-dimensional smoothing function, piecewise linear curves and/or smooth curves, and/or 3D surface graphs may be empirically determined based on testing and or design parameters of the image sensor and may be programmed into the local color channel metrics evaluation function 230.

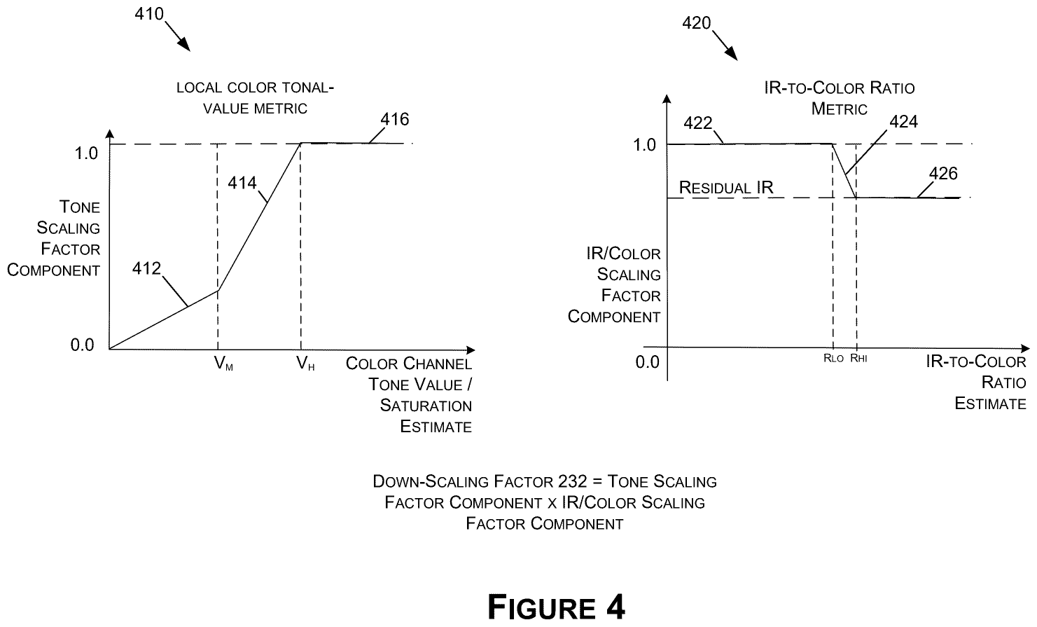

As an example, a 3D surface graph for determining the down-scaling factor 232 may be deconstructed into a set of two-dimensional (2D) piecewise linear curves for a color channel, as shown in FIG. 4. In FIG. 4, a first piecewise linear curve 410 is illustrated for converting the local color-tonal-value metric into a first scaling component referred to as the tone scaling factor component. For a color channel having a value between 0 and a mid-value V_{M}, the first scaling component is computed as a function of a first linear curve 412. For a color channel having a value between the mid-value V_{M} and a high-value V_{H}, the first scaling component is computed as a function of a second linear curve 414. For a color channel having a value greater than the high-value V_{H}, the first scaling component is set to the maximum scaling value of 1 (shown at curve 416).

Also shown in FIG. 4, a second piecewise linear curve 420 is illustrated for converting the IR-to-color ratio metric into a second scaling component referred to as the IR/color scaling factor component. For a color channel having an IR-to-color ratio value between 0 and a value R_{LO}, the second scaling component is set to the maximum scaling value of 1.0 (shown at curve 422). For a color channel having an IR-to-color ratio value between the value R_{LO} and a value R_{HI}, the second scaling component is computed as a function of a second linear curve 424. For a color channel having an IR-to-color ratio greater than the value R_{HI}, the second scaling component is set to the maximum scaling value based on a residual IR factor (shown at curve 426). The down-scaling factor 232 may then be computed as a function of the first scaling component and the second scaling component, such as: Down_Scaling_Factor=first_scaling_component X second_scaling_component, for example. As discussed above, in some embodiments, the up-scaling factor 234 may then be computed as a function of the down-scaling factor 232, and/or determined using other tables and/or curves.

In some embodiments, one or more functions of the locally adaptive IR correction function 130 described herein may be implemented by an ISP pipeline 121 at least in part using a neural network and/or machine learning model. For example, in some embodiments, color channel estimates 212, IR channel estimates 216, a down-scaling factor 232, and/or an up-scaling factor 234 be inferred by one or more machine learning models based on the local support region data 124. In some embodiments, the outputs produced by the first stage correction 220 and/or the second stage correction 240 may be inferred by one or more machine learning models based on the local support region data 124. Moreover, in some embodiments, a neural network and/or machine learning model may be end-to-end trained to implement the locally adaptive IR correction function 130—to input the local support region data 124 and predict the 132 IR-corrected color channels 132 based on the locally adaptive IR adjustments described herein.

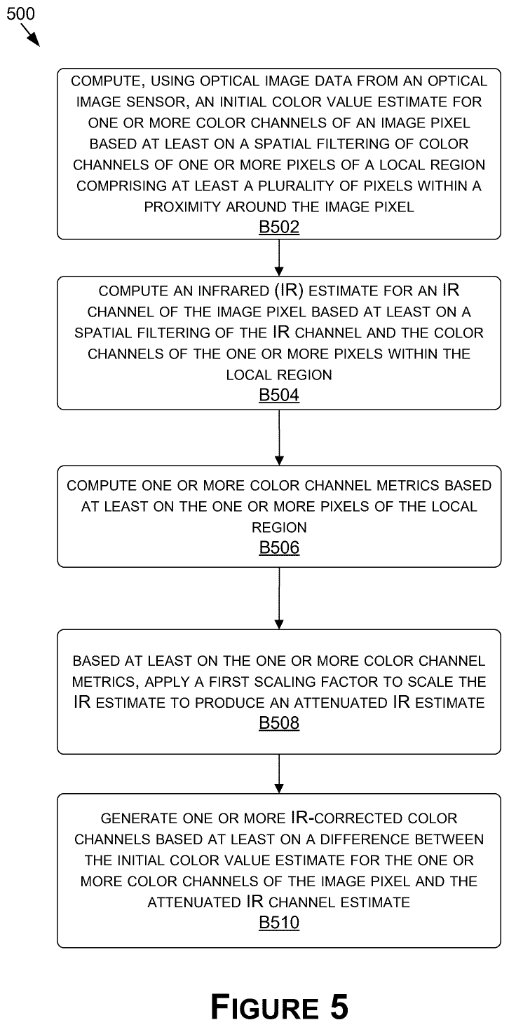

Now referring to FIG. 5, FIG. 5 is a flow diagram showing a method 500 for adaptive IR correction, in accordance with some embodiments of the present disclosure. It should be understood that the features and elements described herein with respect to the method 500 of FIG. 5 may be used in conjunction with, in combination with, or substituted for elements of any of the other embodiments discussed herein and vice versa. Further, it should be understood that the functions, structures, and other descriptions of elements for embodiments described in FIG. 5 may apply to like or similarly named or described elements across any of the figures and/or embodiments described herein and vice versa.

Each block of method 500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, method 500 is described, by way of example, with respect to adaptive IR correction-based ISP system 100 of FIG. 1. However, these methods may additionally or alternatively be executed by any one system, or any combination of systems, including, but not limited to, those described herein.

As discussed herein in greater detail, the method may include generating one or more infrared (IR) corrected color channels for an image pixel based at least on computing an initial color value estimate for one or more color channels of the image pixel based at least on a plurality of pixels within a proximity surrounding the image pixel, and adjusting the initial color value estimate for the one or more color channels based at least on an attenuated IR channel estimate determined based at least on one or more color channel metrics computed for the plurality of pixels within a proximity surrounding the image pixel.

The method 500, at block B502, includes computing, using optical image data from an optical image sensor, an initial color value estimate for one or more color channels of an image pixel based at least on a spatial filtering of color channels of one or more pixels of a local region comprising at least a plurality of pixels within a proximity around the image pixel. The optical image data may comprise a stream of red, green, blue, and IR (RGB-IR) color channel pixel data from an optical image sensor. In some embodiments, the one or more color channels of the image pixel include at least a red channel, a green channel, and a blue channel, defined using a color filter array (CFA) filter applied to the optical image sensor. As shown in FIG. 1, an adaptive IR correction-based ISP system 100 may comprise an ISP 120 that includes an ISP pipeline 121 that inputs image data 110 and generates processed image data 142 based on applying one or more image-processing adjustments to the image data 110. In some embodiments, the ISP pipeline 121 may include a color filter array (CFA) mapping stage 122 that receives image data 110 and separates the image data into color channel data and IR channel data. The image data 110 may be produced by one or more image sensors 105 (e.g., a camera) that includes a CFA of small color filters placed over the photo-sensitive sensor element of the image sensor assigned to a color channel of the image sensors 105. The adaptive IR correction-based ISP system 100 may generate a set of local support region data 124. FIG. 3 illustrates example local support region 302 (e.g., corresponding to local support region data 124) defined for a target image pixel 310 from an image frame 304 (e.g., corresponding to the image data 110). In this example the example local support region 302 includes an immediate pixel neighborhood comprising a proximity of a 5×5 pixel region centered around the target image pixel 310. To compute an initial color value estimate for one or more color channels of a target image pixel 310, the locally adaptive IR correction function 130 may compute the estimate using spatial filtering based on the value of the target image pixel 310 and/or the values of neighborhood pixels 312 that define the local support region 302 for the target image pixel 310. In some embodiments, the size selected to define the local support region 302 may be based on factors such as the particular CFA pattern associated with the image data 110 (e.g., to ensure a sufficient number of neighborhood pixels 312 are included for each color and/or IR channel to perform an accurate spatial filtering). For purpose of non-limiting illustrative examples, FIG. 3B shows an example of a 4×4 RGB-IR CFA at 320, and an example of a 2×2 RGB-IR CFA at 322.

The method 500, at block B504, includes computing an infrared (IR) estimate for an IR channel of the image pixel based at least on a spatial filtering of the IR channel and the color channels of the one or more pixels within the local region. For example, the locally adaptive IR correction function 130 may apply color and IR channel spatial filtering 214 to compute an IR channel estimate 216 based on spatial filtering of not only the IR channel within the local support region but also other color channels as well.

The method 500, at block B506, includes computing one or more color channel metrics based at least on the one or more pixels of the local region. In some embodiments, the local color channel metrics may be computed using raw pixel values represented by the local support region data 124. In some embodiments, the local color channel metrics may be computed using the color channel estimates 212 and/or IR channel estimate 216 computed from the local support region data 124. The one or more color channel metrics include at least one of a color tonal-value metric that represents a degree to which the one or more color channels of the image pixel are saturated, and an IR-over-color ratio metric computed based at least on the initial color value estimate for the one or more color channels of the image pixel.

In some embodiments, a local metric computed by the local color channel metrics evaluation function 230 may include a local color tonal-value metric that represents the degree to which a color channel is saturated and/or how close the color channel is to saturation. In some embodiments, the locally adaptive IR correction function may compute the local color tonal-value metric for a color channel based on spatial filtering of some or all of the color channels within the local support region data 124 (e.g., as a luma calculation) and compare that value with a threshold value used to define saturation for that color channel. In some embodiments, different thresholds may be defined for different color channels. Another local metric that may be computed by the local color channel metrics evaluation function 230 for computing the down-scaling factor 232 may include an IR-to-color ratio metric (e.g., IR/R, IR/B, or IR/G) computed based on one or more of the color channel estimates 212 and IR channel estimate 216. For both the local color tonal-value metrics and IR-to-color ratio metrics, relatively higher values indicate that a relatively greater degree of downward scaling should be applied by the down-scaling factor 232 to the IR channel estimate 212 before the first stage correction 220 subtracts the IR channel estimate 212 from the R, G, and B channels of the color channel estimates 212.

The method 500, at block B508, includes, based at least on the one or more color channel metrics, applying a first scaling factor to scale the IR estimate to produce an attenuated IR estimate. Scaling factors may be determined using the one or more local color channel metrics based on at least one of: a multi-input lookup table, a multidimensional smoothing function, a piecewise linear (PWL) curve, or a three-dimensional surface graph. Using a down-scaling factor, the locally adaptive IR correction function 130 may apply a first stage correction 220 to the color channel estimates 212 that uses an attenuated (down-scaled) IR channel estimate 216 to perform IR value subtraction from the color channel estimates 212. The down-scaling factor 232 may be computed by a local color channel metrics evaluation function 230 based on local color channel metrics derived from the value of the target pixel and/or the local support region data 124. A down-scaling factor 232 may be determined for a target image pixel for each RGB color pixel location of the image data 110 to individually adjust the amount of value subtracted to correct for IR contamination. In some embodiments, based at least on the one or more local color channel metrics, the method may apply a second scaling factor to adjust at least one IR-corrected color channel of the one or more IR-corrected color channels. As illustrated in FIG. 2, local color channel metrics evaluation function 230 may also use the local support region data 124 to compute an up-scaling factor 234 that is applied as a second stage correction 240 following the first stage correction 220. The second stage correction 240 using the up-scaling factor 234 may be used to restore the value in the color channel estimates 212 for a color channel that was initially saturated (e.g., to account for instances where an R, G, or B color channel would still be saturated even when the value corresponding to IR pollution was removed). In some embodiments, one or more machine learning models may be executed to compute at least one of the first scaling factor or the second scaling factor based at least on the local region as represented by the optical image data.

The method 500, at block B510, includes generating one or more IR-corrected color channels based at least on a difference between the initial color value estimate for the one or more color channels of the image pixel and the attenuated IR channel estimate. One or more frames of IR-corrected optical image data may be generated based at least on the one or more IR-corrected color channels. The IR-corrected color channels may include individually corrected color channels for each color channel of the image data. In some embodiments, IR-corrected color channels include RGB color channels that are mapped to a 2×2 RGB CFA, such as (but not limited to) an RGGB Bayer quad pattern as shown in FIG. 3C, for example. In some embodiments, the ISP pipeline 121 may further process the IR-corrected color channels 132 as using a series of image color data channel processing stages 140. Within the plurality of image color data channel processing stages 140, the color data channels are mapped into distinct logical color channels, each having a processing path through the image color data channel processing stages 140. As the color data in the color channels propagates through the image color data channel processing stages 140, each stage applies a filter, transformation, and/or other adjustment to the color channel data, with the processed color channel output of a preceding stage providing the color channel input for the next stage in the sequence of processing stages 140. The particular processes applied to the visible wavelength color data channels by an image color data channel processing stage 140 may include, but are not limited to, demosaicing, white balance correction, tone mapping, color noise reduction, color correction, image sharpening, image scaling, and/or other image adjustments, and so forth as described herein. The results of the processes applied by the image color data channel processing stages 140 may be output from the ISP 120 as processed image data 142. The processed image data 142 resulting output from the ISP pipeline 121 represents the accumulated adjustments to the image data 110 performed by the image color channel processing stages 140 based at least on the IR-corrected color channels 132.

In some embodiments, one or more machine learning models may be executed that generate one or more predictions based at least on one or more image frames generated based at least on the one or more IR-corrected color channels, the one or more color channels, and/or the IR channels. That is, the one or more machine learning models may further use the original color and IR channel data to improve image reconstruction. In some embodiments, the method may further include controlling one or more operations of an ego machine based at least on the one or more IR-corrected color channels. In some embodiments, the one or more processors are further to execute one or more machine learning models to generate the one or more IR-corrected color channels based at least on the local region as represented by the optical image data.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more vision language models (VLMs) or one or more large language models (LLMs), systems for performing light transport simulation, systems for performing collaborative content creation for 3D assets, systems implemented at least partially using cloud computing resources, and/or other types of systems.

### Example Autonomous Vehicle

FIG. 6A is an illustration of an example autonomous vehicle 600, in accordance with some embodiments of the present disclosure. The autonomous vehicle 600 (alternatively referred to herein as the “vehicle 600”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 600 may be capable of functionality in accordance with one or more of Level 3-Level 5 of the autonomous driving levels. The vehicle 600 may be capable of functionality in accordance with one or more of Level 1-Level 5 of the autonomous driving levels. For example, the vehicle 600 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 600 or other machine, such as being fully autonomous, being highly autonomous, being conditionally autonomous, being partially autonomous, providing assistive autonomy, being semi-autonomous, being primarily autonomous, or other designation.

The vehicle 600 may include components such as a chassis, a vehicle body, wheels (e.g., 2, 4, 6, 8, 18, etc.), tires, axles, and other components of a vehicle. The vehicle 600 may include a propulsion system 650, such as an internal combustion engine, hybrid electric power plant, an all-electric engine, and/or another propulsion system type. The propulsion system 650 may be connected to a drive train of the vehicle 600, which may include a transmission, to allow the propulsion of the vehicle 600. The propulsion system 650 may be controlled in response to receiving signals from the throttle/accelerator 652.

A steering system 654, which may include a steering wheel, may be used to steer the vehicle 600 (e.g., along a desired path or route) when the propulsion system 650 is operating (e.g., when the vehicle is in motion). The steering system 654 may receive signals from a steering actuator 656. The steering wheel may be optional for full automation (Level 5) functionality.

The brake sensor system 646 may be used to operate the vehicle brakes in response to receiving signals from the brake actuators 648 and/or brake sensors.

Controller(s) 636, which may include one or more system on chips (SoCs) 604 (FIG. 6C) and/or GPU(s), may provide signals (e.g., representative of commands) to one or more components and/or systems of the vehicle 600. For example, the controller(s) may send signals to operate the vehicle brakes via one or more brake actuators 648, to operate the steering system 654 via one or more steering actuators 656, to operate the propulsion system 650 via one or more throttle/accelerators 652. The controller(s) 636 may include one or more onboard (e.g., integrated) computing devices (e.g., supercomputers) that process sensor signals, and output operation commands (e.g., signals representing commands) to allow autonomous driving and/or to assist a human driver in driving the vehicle 600. The controller(s) 636 may include a first controller 636 for autonomous driving functions, a second controller 636 for functional safety functions, a third controller 636 for artificial intelligence functionality (e.g., computer vision), a fourth controller 636 for infotainment functionality, a fifth controller 636 for redundancy in emergency conditions, and/or other controllers. In some examples, a single controller 636 may handle two or more of the above functionalities, two or more controllers 636 may handle a single functionality, and/or any combination thereof. In some embodiments, one or more functions of the ISP pipeline 121 and/or the local adaptive IR correction function 130 may be executed by one or more of controller(s) 636.

The controller(s) 636 may provide the signals for controlling one or more components and/or systems of the vehicle 600 in response to sensor data received from one or more sensors (e.g., sensor inputs). The sensor data may be received from, for example and without limitation, global navigation satellite systems (“GNSS”) sensor(s) 658 (e.g., Global Positioning System sensor(s)), RADAR sensor(s) 660, ultrasonic sensor(s) 662, LiDAR sensor(s) 664, inertial measurement unit (IMU) sensor(s) 666 (e.g., accelerometer(s), gyroscope(s), magnetic compass(es), magnetometer(s), etc.), microphone(s) 696, stereo camera(s) 668, wide-view camera(s) 670 (e.g., fisheye cameras), infrared camera(s) 672, surround camera(s) 674 (e.g., 360 degree cameras), long-range and/or mid-range camera(s) 698, speed sensor(s) 644 (e.g., for measuring the speed of the vehicle 600), vibration sensor(s) 642, steering sensor(s) 640, brake sensor(s) (e.g., as part of the brake sensor system 646), one or more occupant monitoring system (OMS) sensor(s) 601 (e.g., one or more interior cameras), and/or other sensor types.

One or more of the controller(s) 636 may receive inputs (e.g., represented by input data) from an instrument cluster 632 of the vehicle 600 and provide outputs (e.g., represented by output data, display data, etc.) via a human-machine interface (HMI) display 634, an audible annunciator, a loudspeaker, and/or via other components of the vehicle 600. The outputs may include information such as vehicle velocity, speed, time, map data (e.g., the High Definition (“HD”) map 622 of FIG. 6C), location data (e.g., the vehicle's 600 location, such as on a map), direction, location of other vehicles (e.g., an occupancy grid), information about objects and status of objects as perceived by the controller(s) 636, etc. For example, the HMI display 634 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 600 further includes a network interface 624 which may use one or more wireless antenna(s) 626 and/or modem(s) to communicate over one or more networks. For example, the network interface 624 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 626 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 6B is an example of camera locations and fields of view for the example autonomous vehicle 600 of FIG. 6A, in accordance with some embodiments of the present disclosure. The cameras and respective fields of view are one example embodiment and are not intended to be limiting. For example, additional and/or alternative cameras may be included and/or the cameras may be located at different locations on the vehicle 600. In some embodiments, the image sensor(s) 105 may comprise one or more of the cameras discussed with respect to FIG. 6B.

The camera types for the cameras may include, but are not limited to, digital cameras that may be adapted for use with the components and/or systems of the vehicle 600. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 600 (e.g., front-facing cameras) may be used for surround view, to help identify forward facing paths and obstacles, as well aid in, with the help of one or more controllers 636 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 670 that may be used to perceive objects coming into view from the periphery (e.g., pedestrians, crossing traffic or bicycles). Although only one wide-view camera is illustrated in FIG. 6B, there may be any number (including zero) of wide-view cameras 670 on the vehicle 600. In addition, any number of long-range camera(s) 698 (e.g., a long-view stereo camera pair) may be used for depth-based object detection, especially for objects for which a neural network has not yet been trained. The long-range camera(s) 698 may also be used for object detection and classification, as well as basic object tracking.

Any number of stereo cameras 668 may also be included in a front-facing configuration. In at least one embodiment, one or more of stereo camera(s) 668 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 668 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 668 may be used in addition to, or alternatively from, those described herein.

Cameras with a field of view that include portions of the environment to the side of the vehicle 600 (e.g., side-view cameras) may be used for surround view, providing information used to create and update the occupancy grid, as well as to generate side impact collision warnings. For example, surround camera(s) 674 (e.g., four surround cameras 674 as illustrated in FIG. 6B) may be positioned to on the vehicle 600. The surround camera(s) 674 may include wide-view camera(s) 670, fisheye camera(s), 360 degree camera(s), and/or the like. Four example, four fisheye cameras may be positioned on the vehicle's front, rear, and sides. In an alternative arrangement, the vehicle may use three surround camera(s) 674 (e.g., left, right, and rear), and may leverage one or more other camera(s) (e.g., a forward-facing camera) as a fourth surround view camera.

Cameras with a field of view that include portions of the environment to the rear of the vehicle 600 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 698, stereo camera(s) 668), infrared camera(s) 672, etc.), as described herein.

Cameras with a field of view that include portions of the interior environment within the cabin of the vehicle 600 (e.g., one or more OMS sensor(s) 601) may be used as part of an occupant monitoring system (OMS) such as, but not limited to, a driver monitoring system (DMS). For example, OMS sensors (e.g., the OMS sensor(s) 601) may be used (e.g., by the controller(s) 636) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 6C is a block diagram of an example system architecture for the example autonomous vehicle 600 of FIG. 6A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 600 in FIG. 6C are illustrated as being connected via bus 602. The bus 602 may include a Controller Area Network (CAN) data interface (alternatively referred to herein as a “CAN bus”). A CAN may be a network inside the vehicle 600 used to aid in control of various features and functionality of the vehicle 600, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 602 is described herein as being a CAN bus, this is not intended to be limiting. For example, in addition to, or alternatively from, the CAN bus, FlexRay and/or Ethernet may be used. Additionally, although a single line is used to represent the bus 602, this is not intended to be limiting. For example, there may be any number of busses 602, which may include one or more CAN busses, one or more FlexRay busses, one or more Ethernet busses, and/or one or more other types of busses using a different protocol. In some examples, two or more busses 602 may be used to perform different functions, and/or may be used for redundancy. For example, a first bus 602 may be used for collision avoidance functionality and a second bus 602 may be used for actuation control. In any example, each bus 602 may communicate with any of the components of the vehicle 600, and two or more busses 602 may communicate with the same components. In some examples, each SoC 604, each controller 636, and/or each computer within the vehicle may have access to the same input data (e.g., inputs from sensors of the vehicle 600), and may be connected to a common bus, such the CAN bus.

The vehicle 600 may include one or more controller(s) 636, such as those described herein with respect to FIG. 6A. The controller(s) 636 may be used for a variety of functions. The controller(s) 636 may be coupled to any of the various other components and systems of the vehicle 600, and may be used for control of the vehicle 600, artificial intelligence of the vehicle 600, infotainment for the vehicle 600, and/or the like.

The vehicle 600 may include a system(s) on a chip (SoC) 604. The SoC 604 may include processing circuitry such as, but not limited to, CPU(s) 606, GPU(s) 608, processor(s) 610, cache(s) 612, accelerator(s) 614, data store(s) 616, and/or other components and features not illustrated. The SoC(s) 604 may be used to control the vehicle 600 in a variety of platforms and systems. For example, the SoC(s) 604 may be combined in a system (e.g., the system of the vehicle 600) with an HD map 622 which may obtain map refreshes and/or updates via a network interface 624 from one or more servers (e.g., server(s) 678 of FIG. 6D).

The CPU(s) 606 may include a CPU cluster or CPU complex (alternatively referred to herein as a “CCPLEX”). The CPU(s) 606 may include multiple cores and/or L2 caches. For example, in some embodiments, the CPU(s) 606 may include eight cores in a coherent multi-processor configuration. In some embodiments, the CPU(s) 606 may include four dual-core clusters where each cluster has a dedicated L2 cache (e.g., a 2 MB L2 cache). The CPU(s) 606 (e.g., the CCPLEX) may be configured to support simultaneous cluster operation allowing any combination of the clusters of the CPU(s) 606 to be active at any given time.

The CPU(s) 606 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 606 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 608 may include an integrated GPU (alternatively referred to herein as an “iGPU”). The GPU(s) 608 may be programmable and may be efficient for parallel workloads. The GPU(s) 608, in some examples, may use an enhanced tensor instruction set. The GPU(s) 608 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 608 may include at least eight streaming microprocessors. The GPU(s) 608 may use compute application programming interface(s) (API(s)). In addition, the GPU(s) 608 may use one or more parallel computing platforms and/or programming models (e.g., NVIDIA's CUDA).

The GPU(s) 608 may be power-optimized for best performance in automotive and embedded use cases. For example, the GPU(s) 608 may be fabricated on a Fin field-effect transistor (FinFET). However, this is not intended to be limiting and the GPU(s) 608 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 608 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 608 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 608 to access the CPU(s) 606 page tables directly. In such examples, when the GPU(s) 608 memory management unit (MMU) experiences a miss, an address translation request may be transmitted to the CPU(s) 606. In response, the CPU(s) 606 may look in its page tables for the virtual-to-physical mapping for the address and transmits the translation back to the GPU(s) 608. As such, unified memory technology may allow a single unified virtual address space for memory of both the CPU(s) 606 and the GPU(s) 608, thereby simplifying the GPU(s) 608 programming and porting of applications to the GPU(s) 608.

In addition, the GPU(s) 608 may include an access counter that may keep track of the frequency of access of the GPU(s) 608 to memory of other processors. The access counter may help ensure that memory pages are moved to the physical memory of the processor that is accessing the pages most frequently. In some embodiments, one or more functions of the ISP pipeline 121 and/or the local adaptive IR correction function 130 may be executed by one or more of SoC 604. For example, in some embodiments, one or more machine learning models for performing aspects of the local adaptive IR-correction function 130 may be performed using a neural network architecture on one or more of the GPU(s) 608.

The SoC(s) 604 may include any number of cache(s) 612, including those described herein. For example, the cache(s) 612 may include an L3 cache that is available to both the CPU(s) 606 and the GPU(s) 608 (e.g., that is connected both the CPU(s) 606 and the GPU(s) 608). The cache(s) 612 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 604 may include an arithmetic logic unit(s) (ALU(s)) which may be leveraged in performing processing with respect to any of the variety of tasks or operations of the vehicle 600-such as processing DNNs. In addition, the SoC(s) 604 may include a floating point unit(s) (FPU(s))—or other math coprocessor or numeric coprocessor types—for performing mathematical operations within the system. For example, the SoC(s) 604 may include one or more FPUs integrated as execution units within a CPU(s) 606 and/or GPU(s) 608.

The SoC(s) 604 may include one or more accelerators 614 (e.g., hardware accelerators, software accelerators, or a combination thereof). For example, the SoC(s) 604 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 608 and to off-load some of the tasks of the GPU(s) 608 (e.g., to free up more cycles of the GPU(s) 608 for performing other tasks). As an example, the accelerator(s) 614 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 614 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 608, and by using an inference accelerator, for example, a designer may target either the DLA(s) or the GPU(s) 608 for any function. For example, the designer may focus processing of CNNs and floating point operations on the DLA(s) and leave other functions to the GPU(s) 608 and/or other accelerator(s) 614.

The accelerator(s) 614 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 606. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 614 (e.g., the hardware acceleration cluster) may include a computer vision network on-chip and SRAM, for providing a high-bandwidth, low latency SRAM for the accelerator(s) 614. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 604 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 614 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 666 output that correlates with the vehicle 600 orientation, distance, 3D location estimates of the object obtained from the neural network and/or other sensors (e.g., LiDAR sensor(s) 664 or RADAR sensor(s) 660), among others.

The SoC(s) 604 may include data store(s) 616 (e.g., memory). The data store(s) 616 may be on-chip memory of the SoC(s) 604, which may store neural networks to be executed on the GPU and/or the DLA. In some examples, the data store(s) 616 may be large enough in capacity to store multiple instances of neural networks for redundancy and safety. The data store(s) 616 may comprise L2 or L3 cache(s) 612. Reference to the data store(s) 616 may include reference to the memory associated with the PVA, DLA, and/or other accelerator(s) 614, as described herein.

The SoC(s) 604 may include one or more processor(s) 610 (e.g., embedded processors). The processor(s) 610 may include a boot and power management processor that may be a dedicated processor and subsystem to handle boot power and management functions and related security enforcement. The boot and power management processor may be a part of the SoC(s) 604 boot sequence and may provide runtime power management services. The boot power and management processor may provide clock and voltage programming, assistance in system low power state transitions, management of SoC(s) 604 thermals and temperature sensors, and/or management of the SoC(s) 604 power states. Each temperature sensor may be implemented as a ring-oscillator whose output frequency is proportional to temperature, and the SoC(s) 604 may use the ring-oscillators to detect temperatures of the CPU(s) 606, GPU(s) 608, and/or accelerator(s) 614. If temperatures are determined to exceed a threshold, the boot and power management processor may enter a temperature fault routine and put the SoC(s) 604 into a lower power state and/or put the vehicle 600 into a chauffeur to safe stop mode (e.g., bring the vehicle 600 to a safe stop).

The processor(s) 610 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 610 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 610 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 610 may further include a real-time camera engine that may include a dedicated processor subsystem for handling real-time camera management.

The processor(s) 610 may further include a high-dynamic range signal processor that may include an image signal processor that is a hardware engine that is part of the camera processing pipeline.

The processor(s) 610 may include a video image compositor that may be a processing block (e.g., implemented on a microprocessor) that implements video post-processing functions needed by a video playback application to produce the final image for the player window. The video image compositor may perform lens distortion correction on wide-view camera(s) 670, surround camera(s) 674, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 608 is not required to continuously render new surfaces. Even when the GPU(s) 608 is powered on and active doing 3D rendering, the video image compositor may be used to offload the GPU(s) 608 to improve performance and responsiveness.

The SoC(s) 604 may further include a mobile industry processor interface (MIPI) camera serial interface for receiving video and input from cameras, a high-speed interface, and/or a video input block that may be used for camera and related pixel input functions. The SoC(s) 604 may further include an input/output controller(s) that may be controlled by software and may be used for receiving I/O signals that are uncommitted to a specific role.

The SoC(s) 604 may further include a broad range of peripheral interfaces to allow communication with peripherals, audio codecs, power management, and/or other devices. The SoC(s) 604 may be used to process data from cameras (e.g., connected over Gigabit Multimedia Serial Link and Ethernet), sensors (e.g., LiDAR sensor(s) 664, RADAR sensor(s) 660, etc. that may be connected over Ethernet), data from bus 602 (e.g., speed of vehicle 600, steering wheel position, etc.), data from GNSS sensor(s) 658 (e.g., connected over Ethernet or CAN bus). The SoC(s) 604 may further include dedicated high-performance mass storage controllers that may include their own DMA engines, and that may be used to free the CPU(s) 606 from routine data management tasks.

The SoC(s) 604 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 604 may be faster, more reliable, and even more energy-efficient and space-efficient than conventional systems. For example, the accelerator(s) 614, when combined with the CPU(s) 606, the GPU(s) 608, and the data store(s) 616, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 620) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 608.

In some examples, a CNN for facial recognition and vehicle owner identification may use data from camera sensors to identify the presence of an authorized driver and/or owner of the vehicle 600. The always on sensor processing engine may be used to unlock the vehicle when the owner approaches the driver door and turn on the lights, and, in security mode, to disable the vehicle when the owner leaves the vehicle. In this way, the SoC(s) 604 provide for security against theft and/or carjacking.

In another example, a CNN for emergency vehicle detection and identification may use data from microphones 696 to detect and identify emergency vehicle sirens. In contrast to conventional systems, that use general classifiers to detect sirens and manually extract features, the SoC(s) 604 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 658. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 662, until the emergency vehicle(s) passes.

The vehicle may include a CPU(s) 618 (e.g., discrete CPU(s), or dCPU(s)), that may be coupled to the SoC(s) 604 via a high-speed interconnect (e.g., PCIe). The CPU(s) 618 may include an X86 processor, for example. The CPU(s) 618 may be used to perform any of a variety of functions, including arbitrating potentially inconsistent results between ADAS sensors and the SoC(s) 604, and/or monitoring the status and health of the controller(s) 636 and/or infotainment SoC 630, for example.

The vehicle 600 may include a GPU(s) 620 (e.g., discrete GPU(s), or dGPU(s)), that may be coupled to the SoC(s) 604 via a high-speed interconnect (e.g., NVIDIA's NVLINK). The GPU(s) 620 may provide additional artificial intelligence functionality, such as by executing redundant and/or different neural networks, and may be used to train and/or update neural networks based on input (e.g., sensor data) from sensors of the vehicle 600.

The vehicle 600 may further include the network interface 624 which may include one or more wireless antennas 626 (e.g., one or more wireless antennas for different communication protocols, such as a cellular antenna, a Bluetooth antenna, etc.). The network interface 624 may be used to allow wireless connectivity over the Internet with the cloud (e.g., with the server(s) 678 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 600 information about vehicles in proximity to the vehicle 600 (e.g., vehicles in front of, on the side of, and/or behind the vehicle 600). This functionality may be part of a cooperative adaptive cruise control functionality of the vehicle 600.

The network interface 624 may include a SoC that provides modulation and demodulation functionality and enables the controller(s) 636 to communicate over wireless networks. The network interface 624 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 600 may further include data store(s) 628 which may include off-chip (e.g., off the SoC(s) 604) storage. The data store(s) 628 may include one or more storage elements including RAM, SRAM, DRAM, VRAM, Flash, hard disks, and/or other components and/or devices that may store at least one bit of data.

The vehicle 600 may further include GNSS sensor(s) 658. The GNSS sensor(s) 658 (e.g., GPS, assisted GPS sensors, differential GPS (DGPS) sensors, etc.), to assist in mapping, perception, occupancy grid generation, and/or path planning functions. Any number of GNSS sensor(s) 658 may be used, including, for example and without limitation, a GPS using a USB connector with an Ethernet to Serial (RS-232) bridge.

The vehicle 600 may further include RADAR sensor(s) 660. The RADAR sensor(s) 660 may be used by the vehicle 600 for long-range vehicle detection, even in darkness and/or severe weather conditions. RADAR functional safety levels may be ASIL B. The RADAR sensor(s) 660 may use the CAN and/or the bus 602 (e.g., to transmit data generated using the RADAR sensor(s) 660) for control and to access object tracking data, with access to Ethernet to access raw data in some examples. A wide variety of RADAR sensor types may be used. For example, and without limitation, the RADAR sensor(s) 660 may be suitable for front, rear, and side RADAR use. In some example, Pulse Doppler RADAR sensor(s) are used.

The RADAR sensor(s) 660 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250m range. The RADAR sensor(s) 660 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 600 surroundings at higher speeds with minimal interference from traffic in adjacent lanes. The other two antennae may expand the field of view, making it possible to quickly detect vehicles entering or leaving the vehicle's 600 lane.

Mid-range RADAR systems may include, as an example, a range of up to 660m (front) or 80m (rear), and a field of view of up to 42 degrees (front) or 650 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 600 may further include ultrasonic sensor(s) 662. The ultrasonic sensor(s) 662, which may be positioned at the front, back, and/or the sides of the vehicle 600, may be used for park assist and/or to create and update an occupancy grid. A wide variety of ultrasonic sensor(s) 662 may be used, and different ultrasonic sensor(s) 662 may be used for different ranges of detection (e.g., 2.5m, 4m). The ultrasonic sensor(s) 662 may operate at functional safety levels of ASIL B.

The vehicle 600 may include LiDAR sensor(s) 664. The LiDAR sensor(s) 664 may be used for object and pedestrian detection, emergency braking, collision avoidance, and/or other functions. The LiDAR sensor(s) 664 may be functional safety level ASIL B. In some examples, the vehicle 600 may include multiple LiDAR sensors 664 (e.g., two, four, six, etc.) that may use Ethernet (e.g., to provide data to a Gigabit Ethernet switch).

In some examples, the LiDAR sensor(s) 664 may be capable of providing a list of objects and their distances for a 360-degree field of view. Commercially available LiDAR sensor(s) 664 may have an advertised range of approximately 600m, with an accuracy of 2 cm-3 cm, and with support for a 600 Mbps Ethernet connection, for example. In some examples, one or more non-protruding LiDAR sensors 664 may be used. In such examples, the LiDAR sensor(s) 664 may be implemented as a small device that may be embedded into the front, rear, sides, and/or corners of the vehicle 600. The LiDAR sensor(s) 664, in such examples, may provide up to a 120-degree horizontal and 35-degree vertical field-of-view, with a 200m range even for low-reflectivity objects. Front-mounted LiDAR sensor(s) 664 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 600. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 664 may be less susceptible to motion blur, vibration, and/or shock.

The vehicle may further include IMU sensor(s) 666. The IMU sensor(s) 666 may be located at a center of the rear axle of the vehicle 600, in some examples. The IMU sensor(s) 666 may include, for example and without limitation, an accelerometer(s), a magnetometer(s), a gyroscope(s), a magnetic compass(es), and/or other sensor types. In some examples, such as in six-axis applications, the IMU sensor(s) 666 may include accelerometers and gyroscopes, while in nine-axis applications, the IMU sensor(s) 666 may include accelerometers, gyroscopes, and magnetometers.

In some embodiments, the IMU sensor(s) 666 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 666 may allow the vehicle 600 to estimate heading without requiring input from a magnetic sensor by directly observing and correlating the changes in velocity from GPS to the IMU sensor(s) 666. In some examples, the IMU sensor(s) 666 and the GNSS sensor(s) 658 may be combined in a single integrated unit.

The vehicle may include microphone(s) 696 placed in and/or around the vehicle 600. The microphone(s) 696 may be used for emergency vehicle detection and identification, among other things.

The vehicle may further include any number of camera types, including stereo camera(s) 668, wide-view camera(s) 670, infrared camera(s) 672, surround camera(s) 674, long-range and/or mid-range camera(s) 698, and/or other camera types. The cameras may be used to capture image data around an entire periphery of the vehicle 600. The types of cameras used depends on the embodiments and requirements for the vehicle 600, and any combination of camera types may be used to provide the necessary coverage around the vehicle 600. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 6A and FIG. 6B.

The vehicle 600 may further include vibration sensor(s) 642. The vibration sensor(s) 642 may measure vibrations of components of the vehicle, such as the axle(s). For example, changes in vibrations may indicate a change in road surfaces. In another example, when two or more vibration sensors 642 are used, the differences between the vibrations may be used to determine friction or slippage of the road surface (e.g., when the difference in vibration is between a power-driven axle and a freely rotating axle).

The vehicle 600 may include an ADAS system 638. The ADAS system 638 may include a SoC, in some examples. The ADAS system 638 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 660, LiDAR sensor(s) 664, and/or a camera(s). The ACC systems may include longitudinal ACC and/or lateral ACC. Longitudinal ACC monitors and controls the distance to the vehicle immediately ahead of the vehicle 600 and automatically adjust the vehicle speed to maintain a safe distance from vehicles ahead. Lateral ACC performs distance keeping, and advises the vehicle 600 to change lanes when necessary. Lateral ACC is related to other ADAS applications such as LCA and CWS.

CACC uses information from other vehicles that may be received via the network interface 624 and/or the wireless antenna(s) 626 from other vehicles via a wireless link, or indirectly, over a network connection (e.g., over the Internet). Direct links may be provided by a vehicle-to-vehicle (V2V) communication link, while indirect links may be infrastructure-to-vehicle (12V) communication link. In general, the V2V communication concept provides information about the immediately preceding vehicles (e.g., vehicles immediately ahead of and in the same lane as the vehicle 600), while the 12V communication concept provides information about traffic further ahead. CACC systems may include either or both I2V and V2V information sources. Given the information of the vehicles ahead of the vehicle 600, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 660, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 660, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 600 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 600 if the vehicle 600 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 660, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 600 is backing up. Some RCTW systems include AEB to ensure that the vehicle brakes are applied to avoid a crash. RCTW systems may use one or more rear-facing RADAR sensor(s) 660, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 600, the vehicle 600 itself must, in the case of conflicting results, decide whether to heed the result from a primary computer or a secondary computer (e.g., a first controller 636 or a second controller 636). For example, in some embodiments, the ADAS system 638 may be a backup and/or secondary computer for providing perception information to a backup computer rationality module. The backup computer rationality monitor may run a redundant diverse software on hardware components to detect faults in perception and dynamic driving tasks. Outputs from the ADAS system 638 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 604.

In other examples, ADAS system 638 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 638 may be fed into the primary computer's perception block and/or the primary computer's dynamic driving task block. For example, if the ADAS system 638 indicates a forward crash warning due to an object immediately ahead, the perception block may use this information when identifying objects. In other examples, the secondary computer may have its own neural network which is trained and thus reduces the risk of false positives, as described herein.

The vehicle 600 may further include the infotainment SoC 630 (e.g., an in-vehicle infotainment system (IVI)). Although illustrated and described as a SoC, the infotainment system may not be a SoC, and may include two or more discrete components. The infotainment SoC 630 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 600. For example, the infotainment SoC 630 may radios, disk players, navigation systems, video players, USB and Bluetooth connectivity, carputers, in-car entertainment, Wi-Fi, steering wheel audio controls, hands free voice control, a heads-up display (HUD), an HMI display 634, a telematics device, a control panel (e.g., for controlling and/or interacting with various components, features, and/or systems), and/or other components. The infotainment SoC 630 may further be used to provide information (e.g., visual and/or audible) to a user(s) of the vehicle, such as information from the ADAS system 638, autonomous driving information such as planned vehicle maneuvers, trajectories, surrounding environment information (e.g., intersection information, vehicle information, road information, etc.), and/or other information.

The infotainment SoC 630 may include GPU functionality. The infotainment SoC 630 may communicate over the bus 602 (e.g., CAN bus, Ethernet, etc.) with other devices, systems, and/or components of the vehicle 600. In some examples, the infotainment SoC 630 may be coupled to a supervisory MCU such that the GPU of the infotainment system may perform some self-driving functions in the event that the primary controller(s) 636 (e.g., the primary and/or backup computers of the vehicle 600) fail. In such an example, the infotainment SoC 630 may put the vehicle 600 into a chauffeur to safe stop mode, as described herein.

The vehicle 600 may further include an instrument cluster 632 (e.g., a digital dash, an electronic instrument cluster, a digital instrument panel, etc.). The instrument cluster 632 may include a controller and/or supercomputer (e.g., a discrete controller or supercomputer). The instrument cluster 632 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 630 and the instrument cluster 632. As such, the instrument cluster 632 may be included as part of the infotainment SoC 630, or vice versa.

FIG. 6D is a system diagram for communication between cloud-based server(s) and the example autonomous vehicle 600 of FIG. 6A, in accordance with some embodiments of the present disclosure. The system 676 may include server(s) 678, network(s) 690, and vehicles, including the vehicle 600. The server(s) 678 may include a plurality of GPUs 684(A)-684(H) (collectively referred to herein as GPUs 684), PCIe switches 682(A)-682(D) (collectively referred to herein as PCIe switches 682), and/or CPUs 680(A)-680(B) (collectively referred to herein as CPUs 680). The GPUs 684, the CPUs 680, and the PCIe switches may be interconnected with high-speed interconnects such as, for example and without limitation, NVLink interfaces 688 developed by NVIDIA and/or PCIe connections 686. In some examples, the GPUs 684 are connected via NVLink and/or NVSwitch SoC and the GPUs 684 and the PCIe switches 682 are connected via PCIe interconnects. Although eight GPUs 684, two CPUs 680, and two PCIe switches are illustrated, this is not intended to be limiting. Depending on the embodiment, each of the server(s) 678 may include any number of GPUs 684, CPUs 680, and/or PCIe switches. For example, the server(s) 678 may each include eight, sixteen, thirty-two, and/or more GPUs 684.

The server(s) 678 may receive, over the network(s) 690 and from the vehicles, image data representative of images showing unexpected or changed road conditions, such as recently commenced road-work. The server(s) 678 may transmit, over the network(s) 690 and to the vehicles, neural networks 692, updated neural networks 692, and/or map information 694, including information regarding traffic and road conditions. The updates to the map information 694 may include updates for the HD map 622, such as information regarding construction sites, potholes, detours, flooding, and/or other obstructions. In some examples, the neural networks 692, the updated neural networks 692, and/or the map information 694 may have resulted from new training and/or experiences represented in data received from any number of vehicles in the environment, and/or based on training performed at a datacenter (e.g., using the server(s) 678 and/or other servers).

The server(s) 678 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 690, and/or the machine learning models may be used by the server(s) 678 to remotely monitor the vehicles.

In some examples, the server(s) 678 may receive data from the vehicles and apply the data to up-to-date real-time neural networks for real-time intelligent inferencing. The server(s) 678 may include deep-learning supercomputers and/or dedicated AI computers powered by GPU(s) 684, such as a DGX and DGX Station machines developed by NVIDIA. However, in some examples, the server(s) 678 may include deep learning infrastructure that use only CPU-powered datacenters.

The deep-learning infrastructure of the server(s) 678 may be capable of fast, real-time inferencing, and may use that capability to evaluate and verify the health of the processors, software, and/or associated hardware in the vehicle 600. For example, the deep-learning infrastructure may receive periodic updates from the vehicle 600, such as a sequence of images and/or objects that the vehicle 600 has located in that sequence of images (e.g., via computer vision and/or other machine learning object classification techniques). The deep-learning infrastructure may run its own neural network to identify the objects and compare them with the objects identified by the vehicle 600 and, if the results do not match and the infrastructure concludes that the AI in the vehicle 600 is malfunctioning, the server(s) 678 may transmit a signal to the vehicle 600 instructing a fail-safe computer of the vehicle 600 to assume control, notify the passengers, and complete a safe parking maneuver.

For inferencing, the server(s) 678 may include the GPU(s) 684 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 7 is a block diagram of an example computing device(s) 700 suitable for use in implementing some embodiments of the present disclosure. Computing device 700 may include an interconnect system 702 that directly or indirectly couples the following devices: memory 704, one or more central processing units (CPUs) 706, one or more graphics processing units (GPUs) 708, a communication interface 710, input/output (I/O) ports 712, input/output components 714, a power supply 716, one or more presentation components 718 (e.g., display(s)), and one or more logic units 720. In at least one embodiment, the computing device(s) 700 may comprise one or more virtual machines (VMs), and/or any of the components thereof may comprise virtual components (e.g., virtual hardware components). For non-limiting examples, one or more of the GPUs 708 may comprise one or more vGPUs, one or more of the CPUs 706 may comprise one or more vCPUs, and/or one or more of the logic units 720 may comprise one or more virtual logic units. As such, a computing device(s) 700 may include discrete components (e.g., a full GPU dedicated to the computing device 700), virtual components (e.g., a portion of a GPU dedicated to the computing device 700), or a combination thereof.

Although the various blocks of FIG. 7 are shown as connected via the interconnect system 702 with lines, this is not intended to be limiting and is for clarity only. For example, in some embodiments, a presentation component 718, such as a display device, may be considered an I/O component 714 (e.g., if the display is a touch screen). As another example, the CPUs 706 and/or GPUs 708 may include memory (e.g., the memory 704 may be representative of a storage device in addition to the memory of the GPUs 708, the CPUs 706, and/or other components). As such, the computing device of FIG. 7 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 7.

The interconnect system 702 may represent one or more links or busses, such as an address bus, a data bus, a control bus, or a combination thereof. The interconnect system 702 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 706 may be directly connected to the memory 704. Further, the CPU 706 may be directly connected to the GPU 708. Where there is direct, or point-to-point connection between components, the interconnect system 702 may include a PCIe link to carry out the connection. In these examples, a PCI bus need not be included in the computing device 700. In some embodiments, one or more functions of the ISP pipeline 121 and/or the local adaptive IR correction function 130 may be executed by one or more of the CPUs 706 and/or GPUs 708.

The memory 704 may include any of a variety of computer-readable media. The computer-readable media may be any available media that may be accessed by the computing device 700. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 704 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 700. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 706 may be configured to execute at least some of the computer-readable instructions to control one or more components of the computing device 700 to perform one or more of the methods and/or processes described herein. The CPU(s) 706 may each include one or more cores (e.g., one, two, four, eight, twenty-eight, seventy-two, etc.) that are capable of handling a multitude of software threads simultaneously. The CPU(s) 706 may include any type of processor, and may include different types of processors depending on the type of computing device 700 implemented (e.g., processors with fewer cores for mobile devices and processors with more cores for servers). For example, depending on the type of computing device 700, the processor may be an Advanced RISC Machines (ARM) processor implemented using Reduced Instruction Set Computing (RISC) or an x86 processor implemented using Complex Instruction Set Computing (CISC). The computing device 700 may include one or more CPUs 706 in addition to one or more microprocessors or supplementary co-processors, such as math co-processors.

In addition to or alternatively from the CPU(s) 706, the GPU(s) 708 may be configured to execute at least some of the computer-readable instructions to control one or more components of the computing device 700 to perform one or more of the methods and/or processes described herein. One or more of the GPU(s) 708 may be an integrated GPU (e.g., with one or more of the CPU(s) 706 and/or one or more of the GPU(s) 708 may be a discrete GPU. In embodiments, one or more of the GPU(s) 708 may be a coprocessor of one or more of the CPU(s) 706. The GPU(s) 708 may be used by the computing device 700 to render graphics (e.g., 3D graphics) or perform general purpose computations. For example, the GPU(s) 708 may be used for General-Purpose computing on GPUs (GPGPU). The GPU(s) 708 may include hundreds or thousands of cores that are capable of handling hundreds or thousands of software threads simultaneously. The GPU(s) 708 may generate pixel data for output images in response to rendering commands (e.g., rendering commands from the CPU(s) 706 received via a host interface). The GPU(s) 708 may include graphics memory, such as display memory, for storing pixel data or any other suitable data, such as GPGPU data. The display memory may be included as part of the memory 704. The GPU(s) 708 may include two or more GPUs operating in parallel (e.g., via a link). The link may directly connect the GPUs (e.g., using NVLINK) or may connect the GPUs through a switch (e.g., using NVSwitch). When combined together, each GPU 708 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 706 and/or the GPU(s) 708, the logic unit(s) 720 may be configured to execute at least some of the computer-readable instructions to control one or more components of the computing device 700 to perform one or more of the methods and/or processes described herein. In embodiments, the CPU(s) 706, the GPU(s) 708, and/or the logic unit(s) 720 may discretely or jointly perform any combination of the methods, processes and/or portions thereof. One or more of the logic units 720 may be part of and/or integrated in one or more of the CPU(s) 706 and/or the GPU(s) 708 and/or one or more of the logic units 720 may be discrete components or otherwise external to the CPU(s) 706 and/or the GPU(s) 708. In embodiments, one or more of the logic units 720 may be a coprocessor of one or more of the CPU(s) 706 and/or one or more of the GPU(s) 708.

Examples of the logic unit(s) 720 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 710 may include one or more receivers, transmitters, and/or transceivers that allow the computing device 700 to communicate with other computing devices via an electronic communication network, included wired and/or wireless communications. The communication interface 710 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 720 and/or communication interface 710 may include one or more data processing units (DPUs) to transmit data received over a network and/or through interconnect system 702 directly to (e.g., a memory of) one or more GPU(s) 708.

The I/O ports 712 may allow the computing device 700 to be logically coupled to other devices including the I/O components 714, the presentation component(s) 718, and/or other components, some of which may be built in to (e.g., integrated in) the computing device 700. Illustrative I/O components 714 include a microphone, mouse, keyboard, joystick, game pad, game controller, satellite dish, scanner, printer, wireless device, etc. The I/O components 714 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 700. The computing device 700 may be include depth cameras, such as stereoscopic camera systems, infrared camera systems, RGB camera systems, touchscreen technology, and combinations of these, for gesture detection and recognition. Additionally, the computing device 700 may include accelerometers or gyroscopes (e.g., as part of an inertia measurement unit (IMU)) that allow detection of motion. In some examples, the output of the accelerometers or gyroscopes may be used by the computing device 700 to render immersive augmented reality or virtual reality.

The power supply 716 may include a hard-wired power supply, a battery power supply, or a combination thereof. The power supply 716 may provide power to the computing device 700 to allow the components of the computing device 700 to operate.

The presentation component(s) 718 may include a display (e.g., a monitor, a touch screen, a television screen, a heads-up-display (HUD), other display types, or a combination thereof), speakers, and/or other presentation components. The presentation component(s) 718 may receive data from other components (e.g., the GPU(s) 708, the CPU(s) 706, DPUs, etc.), and output the data (e.g., as an image, video, sound, etc.). In some embodiments, one or more of the presentation component(s) 718 may comprise the presentation module 160 and be used to display visualization(s) 165.

### Example Data Center

FIG. 8 illustrates an example data center 800 that may be used in at least one embodiments of the present disclosure. The data center 800 may include a data center infrastructure layer 810, a framework layer 820, a software layer 830, and/or an application layer 840.

As shown in FIG. 8, the data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 816(1)-816 (N) may correspond to a server having one or more of the above-mentioned computing resources. In addition, in some embodiments, the node C.R.s 816(1)-8161(N) may include one or more virtual components, such as vGPUs, vCPUs, and/or the like, and/or one or more of the node C.R.s 816(1)-816(N) may correspond to a virtual machine (V_{M}).

In at least one embodiment, grouped computing resources 814 may include separate groupings of node C.R.s 816 housed within one or more racks (not shown), or many racks housed in data centers at various geographical locations (also not shown). Separate groupings of node C.R.s 816 within grouped computing resources 814 may include grouped compute, network, memory or storage resources that may be configured or allocated to support one or more workloads. In at least one embodiment, several node C.R.s 816 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 812 may configure or otherwise control one or more node C.R.s 816(1)-816(N) and/or grouped computing resources 814. In at least one embodiment, resource orchestrator 812 may include a software design infrastructure (SDI) management entity for the data center 800. The resource orchestrator 812 may include hardware, software, or some combination thereof. In some embodiments, one or more functions of the ISP pipeline 121 and/or the local adaptive IR correction function 130 may be executed by one or more of the node C.R.s 816(1)-816(N).

In at least one embodiment, as shown in FIG. 8, framework layer 820 may include a job scheduler 833, a configuration manager 834, a resource manager 836, and/or a distributed file system 838. The framework layer 820 may include a framework to support software 832 of software layer 830 and/or one or more application(s) 842 of application layer 840. The software 832 or application(s) 842 may respectively include web-based service software or applications, such as those provided by Amazon Web Services, Google Cloud and Microsoft Azure. The framework layer 820 may be, but is not limited to, a type of free and open-source software web application framework such as Apache Spark™ (hereinafter “Spark”) that may use distributed file system 838 for large-scale data processing (e.g., “big data”). In at least one embodiment, job scheduler 833 may include a Spark driver to facilitate scheduling of workloads supported by various layers of data center 800. The configuration manager 834 may be capable of configuring different layers such as software layer 830 and framework layer 820 including Spark and distributed file system 838 for supporting large-scale data processing. The resource manager 836 may be capable of managing clustered or grouped computing resources mapped to or allocated for support of distributed file system 838 and job scheduler 833. In at least one embodiment, clustered or grouped computing resources may include grouped computing resource 814 at data center infrastructure layer 810. The resource manager 836 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 838 of framework layer 820. One or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816 (N), grouped computing resources 814, and/or distributed file system 838 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 834, resource manager 836, and resource orchestrator 812 may implement any number and type of self-modifying actions based on any amount and type of data acquired in any technically feasible fashion. Self-modifying actions may relieve a data center operator of data center 800 from making possibly bad configuration decisions and possibly avoiding underutilized and/or poor performing portions of a data center.

The data center 800 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 800. In at least one embodiment, trained or deployed machine learning models corresponding to one or more neural networks may be used to infer or predict information using resources described above with respect to the data center 800 by using weight parameters calculated through one or more training techniques, such as but not limited to those described herein.

In at least one embodiment, the data center 800 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 700 of FIG. 7—e.g., each device may include similar components, features, and/or functionality of the computing device(s) 700. In addition, where backend devices (e.g., servers, NAS, etc.) are implemented, the backend devices may be included as part of a data center 800, an example of which is described in more detail herein with respect to FIG. 8.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 700 described herein with respect to FIG. 7. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising circuitry to:
compute, using optical image data from an optical image sensor, an initial color value estimate for one or more color channels of an image pixel based at least on a spatial filtering of color channels of one or more pixels of a local region comprising at least a plurality of pixels within a proximity around the image pixel;
compute an IR estimate for an IR channel of the image pixel based at least on a spatial filtering of the IR channel and the color channels of the one or more pixels within the local region;
compute one or more color channel metrics based at least on the one or more pixels of the local region;
based at least on the one or more color channel metrics, apply a first scaling factor to scale the IR estimate to produce an attenuated IR estimate; and
generate one or more IR-corrected color channels based at least on a difference between the initial color value estimate for the one or more color channels of the image pixel and the attenuated IR channel estimate.

2. The one or more processors of claim 1, wherein the one or more processors are further to:
based at least on the one or more color channel metrics, apply a second scaling factor to adjust at least one IR-corrected color channel of the one or more IR-corrected color channels.

3. The one or more processors of claim 2, wherein the one or more processors are further to execute one or more machine learning models to compute at least one of the first scaling factor or the second scaling factor based at least on the local region as represented by the optical image data.

4. The one or more processors of claim 1, wherein the one or more color channel metrics include at least one of:
a color tonal-value metric that represents a degree to which the one or more color channels of the image pixel are saturated; and
an IR-over-color ratio metric computed based at least on the initial color value estimate for the one or more color channels of the image pixel.

5. The one or more processors of claim 1, wherein the one or more processors are further to execute one or more machine learning models that generate one or more predictions based at least on one or more image frames generated based at least on one or more of:
the one or more IR-corrected color channels;
the one or more color channels; and
the IR channel.

6. The one or more processors of claim 1, wherein the one or more processors are further to control one or more operations of an ego machine based at least on the one or more IR-corrected color channels.

7. The one or more processors of claim 1, wherein the one or more processors are further to generate one or more frames of IR-corrected optical image data based at least on the one or more IR-corrected color channels.

8. The one or more processors of claim 1, wherein the one or more color channels of the image pixel include at least a red channel, a green channel, and a blue channel, defined using a color filter array (CFA) filter applied to the optical image sensor.

9. The one or more processors of claim 1, wherein the one or more processors are further to:
determine the first scaling factor from the one or more local color channel metrics based on at least one of: a multi-input lookup table, a multidimensional smoothing function, a piecewise linear (PWL) curve, or a three-dimensional surface graph.

10. The one or more processors of claim 1, wherein the one or more processors are further to execute one or more machine learning models to generate the one or more IR-corrected color channels based at least on the local region, as represented by the optical image data.

11. The one or more processors of claim 1, wherein the circuitry is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to:
compute, using optical image data, an initial color value estimate for one or more color channels of an image pixel based at least on one or more pixels of a local region comprising at least a plurality of pixels within a proximity surrounding the image pixel;
compute one or more scaling factors based at least on the one or more pixels of the local region; and
generate one or more infrared (IR)-corrected color channels by scaling an IR channel estimate based at least on the one or more scaling factors to produce an attenuated IR channel estimate, and adjusting the initial color value estimate for the one or more color channels based at least on the attenuated IR channel estimate.

13. The system of claim 12, wherein the one or more processors are further to:
based at least on the one or more scaling factors, adjust at least one IR-corrected color channel of the one or more IR-corrected color channels.

14. The system of claim 12, wherein the one or more processors are further to:
compute the one or more scaling factors based at least on one or more color channel metrics determined based at least on the one or more pixels of the local region, wherein the one or more color channel metrics include at least one of:
a color tonal-value metric that represents a degree to which the one or more color channels of the image pixel are saturated; and
an IR-over-color ratio metric computed based at least on the initial color value estimate for the one or more color channels of the image pixel.

15. The system of claim 12, wherein the one or more processors are further to execute one or more machine learning models to generate the one or more scaling factors based at least on the local region, as represented by the optical image data.

16. The system of claim 12, wherein the optical image data comprises red, green, blue, and IR (RGB-IR) color channel pixel data from an optical image sensor.

17. The system of claim 12, wherein the one or more processors are further to execute a machine learning model that generates one or more predictions based at least on one or more image frames generated based at least on the one or more IR-corrected color channels.

18. The system of claim 12, wherein the one or more processors are further to control one or more operations of an ego machine based at least on the one or more IR-corrected color channels.

19. The system of claim 12, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more vision language models (VLMs);
a system implementing one or more large language models (LLMs);
a system for generating synthetic data;
a system for generating synthetic data using AI;
a system incorporating one or more virtual machines (VMs);
a system implemented at least partially in a data center; or
a system implemented at least partially using cloud computing resources.

20. A method comprising:
generating one or more infrared (IR) corrected color channels for an image pixel based at least on computing an initial color value estimate for one or more color channels of the image pixel based at least on a plurality of pixels within a proximity surrounding the image pixel, and adjusting the initial color value estimate for the one or more color channels based at least on an attenuated IR channel estimate determined based at least on one or more color channel metrics computed for the plurality of pixels within a proximity surrounding the image pixel.
